(19) United States
(12) Patent Application Publication
(10) Pub. No.: US 2018/0225748 A1
(43) Pub. Date: Aug. 9, 2018

(54) F & I MENU SYSTEM

(71) Applicant: ITAP MENU LLC , Carmel IN 46032, Carmel, IN (US)

(72) Inventors: Ozan Selcuk, Westfield, IN (US); Michael T. Wilson, Noblesville, IN (US); Shawn A. McCool, Fishers, IN (US); Scott W. Beardsley, Chesterfield, IN (US); Michael C. Warren, Noblesville, IN (US); Timothy J. Moriarity, Zionsville, IN (US)

(21) Appl. No.: 15/947,214

(22) Filed: Apr. 6, 2018

Related U.S. Application Data
(63) Continuation-in-part of application No. 13/494,613, filed on Jun. 12, 2012, now abandoned.
Application No. 13/494,613 is a continuation of application No. 14/171,174, filed on Feb. 3, 2014.
(60) Provisional application No. 61/496,854, filed on Jun. 14, 2011.

(51) Int. Cl. G06Q 30/06

(52) U.S. Cl. CPC G06Q 30/0643; G06Q 30/0621; G06Q 30/0601

(57) ABSTRACT

An F&I menu system for the sale of vehicles, or other products which are often financed and which includes multiple options. A display shows the price of the vehicle with and without the options, and as icons representing the optional items are selected and deselected, the with-options price is automatically updated. The display may include an area showing a predetermined set of options and an associated price, and individual icons may be dragged and dropped into a separate selection area whose display is suppressed until an icon is moved into the selection area. Once a sale is completed, the backend system may generate customized electronic follow up communications to customers concerning certain options the customer originally declined to purchase for their vehicle as well as a timeline display of the customer's interaction with the F&I menu system display.

### RELATED APPLICATIONS

This application is a continuation of application Ser. No. 14/171,174 filed 3 Feb. 2014, which is a continuation-in-part of co-pending U.S. non-provisional patent application Ser. No. 13/494,613 filed 12 Jun. 2012 which claims the benefit of provisional application Ser. No. 61/496,854 filed 14 Jun. 2011, each of which are incorporated herein by reference. This application also claims the benefit of provisional application Ser. No. 61/919,234 filed 20 Dec. 2013, the disclosure of which is also incorporated by reference.

### FIELD OF THE INVENTION

The present disclosure relates to systems used to present purchase options to purchasers in connection with the sale of vehicles or other products having multiple optional features.

### BACKGROUND

F&I Menu selling refers to the finance and insurance (F&I) portion of a vehicle acquisition transaction in which, along with the financing terms of the transaction (whether sale or lease), the vehicle dealer provides to the vehicle purchaser/lessee a number of options—a menu—of additional products and services that the purchaser can choose to include into the vehicle purchase transaction. For example, an F&I menu might include optional items such as extended warranty products, paint and exterior protection, anti-theft registration, pre-paid maintenance, identity theft protection, tire and wheel protection, door ding protection, etc. For a sale or lease of a product like a cell phone, a F&I menu, (or optional items) might include, extended warranty plans, data access plans, roaming plans, international calling or roaming plans, loss or theft insurance, cloud or other data storage services, etc.

In the context of vehicles, some F&I menu systems allow the vehicle dealership finance manager to create one or more static options, which are then presented to the vehicle purchaser either on paper or on a computer screen. The purchaser can then select from these options the products and services that he or she wishes to add. If the purchaser wishes to change the terms of the financing agreement or to select options that aren't presented on the finance manager's pre-created menu, the finance manager must go back to the F&I system to adjust the offered menu options and re-present the new options to the purchaser.

Existing F&I menu systems often result in salespersons failing to consider presenting to a customer all the items that could be offered to a customer. Many F&I menu systems are clumsy and slow to use, because they do not instantly calculate the selected menu items being considered by a customer. Instead, it takes time for a salesperson to calculate the cost of items selected by a customer. This does not allow a customer to immediately see the cost of various menu options. This can result in the customer becoming frustrated with the menu section process. In addition, existing menu systems do not allow an organization to require, or encourage, that one or more specific menu items be presented to each customer. Existing systems also do not facilitate a customer quickly and easily getting more detail about specific menu offerings.

### SUMMARY OF THE INVENTION

An F&I Menu system is disclosed that provides interactivity between the finance manager/salesperson and the purchaser. Directly on a mobile device such as a tablet computer, the finance manager and the purchaser can adjust the options that are presented and the options that are selected for inclusion with the vehicle purchase, how the prices of these options appear (the total price of the option or the option's impact on the financed payment), the financing terms (the number of months, the type of transaction (lease, financing, cash, etc.), and more. Selections and adjustments can be made in real time by the purchaser, and the pricing and financing calculations are adjusted by the system in real time on the screen. When the purchaser makes final selections, the F&I menu system records the transaction, captures the signatures, and facilitates printing of a summary of the selections made. A vehicle purchaser has control over the information that supports his or her purchasing decisions for F&I products and services.

### BRIEF DESCRIPTION OF THE DRAWINGS

FIG. 1 shows an F&I menu system before any F&I menu items are selected, and with six recommended F&I menu items.

FIG. 2 shows an F&I menu system with five of 8 options selected.

FIG. 3 shows vehicle cost information before any F&I menu items are selected.

FIG. 4 shows how F&I menu items may be selected by dragging associated icons from an all-options display area to a selected display area, and how the vehicle cost or amount financed information is instantly updated to reflect the selected item.

FIG. 5 shows how selecting an additional (third) F&I menu item further instantly updates the vehicle cost or amount financed information.

FIG. 6 shows a screen that can be accessed by clicking on the “Amount Financed” button of FIGS. 1-5, and in which an initial payment amount may be interactively changed.

FIG. 7 shows the use of slider bar to change the amount of an initial payment, and the corresponding instantaneous change to the vehicle cost or amount financed information.

FIG. 8 shows how further alteration of the initial payment results in further instantaneous change to the vehicle cost or amount financed information.

FIG. 9 shows an F&I menu system configured to display different combinations of F&I menu items, and their associated costs.

FIG. 10 is another embodiment of an F&I menu system before any F&I menu items are selected.

FIG. 11 shows how additional information regarding an F&I menu item may be displayed in response to user input, for example, by tapping on the icon for the optional item.

FIG. 12 shows the display of even “more” information about a particular F&I menu item.

FIGS. 13 and 14 shows the display of a window for displaying a video clip describing a particular F&I menu item.

FIG. 15 shows the display of a window for displaying additional pricing information for a particular F&I menu item.

FIG. 16 shows the display wherein an icon for an optional item is being dragged from an unselected options area (on the far left) to a selected options area, but before the dragging is complete, and how the base price area at the top (displayed a base price in the format of an amount financed of $24,615.20) matches the base cost of the product in the with-options price area in lower right corner.

FIG. 17 shows how the selected options area may appear after the icon for the selection option item icon of FIG. 16 is fully dragged, and how the base cost of the product in the with-options price area in lower right corner has been automatically updated (including recalculation of interest) so that the updated price can be compared to the cost in the base price area.

FIG. 18 shows how the selected options area may appear after a second option item icon is fully dragged into it, and how the base cost of the product in the with-options price area in lower right corner has been further automatically updated (including recalculation of interest) so that the revised updated price can be compared to the cost in the base price area.

FIG. 19 shows another embodiment for displaying a selected options area labeled “accept” and an unselected options area labeled “decline,” and in which no “recommended” options are displayed, and, means for displaying two signature areas and capturing handwritten signatures.

FIG. 20 shows a captured signature representing the customer's acknowledgment that specified options were offered for purchase but are being declined.

FIG. 21 shows a menu building screen of a back-end system whereby a salesperson may select what options and features a customer will see on the system.

FIG. 22 shows a pricing screen that may be displayed in response to user input for the icon, in this case, depressing the icon for five seconds, to allow a salesperson user to change the price of the optional item.

FIG. 23 shows another F&I menu system wherein an options or base display area is shown, a recommended display area is shown, but display of a customer selection display area has been suppressed, illustrating a first screen or step of a feature of the F&I menu system, labeled as “Step 1” in FIG. 23.

FIG. 24 illustrates selection of an icon from the base display area into the suppressed selection area, labeled as “Step 2” of the feature.

FIG. 25 illustrates un-suppression and the display of the selection area in response to selection of an icon from the base area, the selected icon displayed in the selection area along with financial parameters regarding the icon displayed in the selection area, labeled as “Step 3” of the feature.

FIG. 26 illustrates selection and de-selection of icons from the base and selection areas, wherein the financial parameters displayed in the selection area update in response thereto, labeled as “Step 4” in FIG. 26.

FIG. 27 illustrates a final selection of icons from the base display area into the selection area and the updated financial parameters regarding the base cost of the product and the icons in the selection area, labeled as “Step 5” in FIG. 27.

FIG. 28 shows another F&I menu system before any F&I menu items are selected by a customer with six F&I menu items in a recommended options display area and displaying a total price for the vehicle and the six F&I menu items in the recommended options display area within a finance parameters or terms options area of the recommended options display area.

FIG. 29 shows an editor screen for vehicle price that can be accessed by touching the “Vehicle Price” text box of the F&I menu system of FIG. 28, and in which the vehicle price may be interactively changed.

FIG. 30 shows the F&I menu system of FIG. 28 after the vehicle price has been interactively changed via the editor screen and displaying a revised total price for the vehicle and the six F&I menu items in the recommended options display area within the finance terms options area of the recommended options display area.

FIG. 31 shows the F&I menu system of FIG. 28 with the three finance terms options of the finance terms options area displayed in the recommended options display area.

FIG. 32 shows the F&I menu system of FIG. 31 additionally displaying a finance terms editor opened upon touching, holding and releasing the finance term option of the finance terms options area.

FIG. 33 shows the F&I menu system of FIG. 28 with the three finance terms options of the finance terms options area displayed in the recommended options display area.

FIG. 34 shows the lease editor screen opened after touching, holding and releasing the lease term option of the finance terms options wherein lease terms may be modified.

FIG. 35 shows the declination screen which shows the buyer the options he is accepting and those he is declining and provides a signature block for the buyer to specifically acknowledge his acceptance/declination of specified options.

FIG. 36 shows a menu creating screen of a back-end system whereby customer information for a proposed deal may be entered manually or pulled from a DMS.

FIG. 37 shows the selection of the “sell more” tab of the back-end system through which the salesperson user initiates a follow up campaign to selected purchasers concerning their previously declined F&I menu items.

FIG. 38 shows a continuation of the “sell more” tab of FIG. 37 showing a preview of the email that will be sent out to the selected customer shown in FIG. 37 an including a hyperlink.

FIG. 39 shows the customized information that is displayed when the customer clicks the hyperlink in the email of FIG. 38.

FIG. 40 shows a continuation of the customized information displayed by following the hyperlink of FIG. 38.

FIG. 41 shows the selection of the “sell more” tab of the back-end system as in FIG. 37 with the search parameters expanded so as to encompass a number of different deals/menus, and showing the unselected F&I menu items for the highlighted first menu/deal in the list.

FIG. 42 shows the “sell more” tab of FIG. 41 with the third menu/deal in the list being highlighted and having that menu/deal's unselected F&I menu items displayed.

FIG. 43 shows the results of a search for available Menus to be analyzed in a timeline report.

FIG. 44 shows the introductory screen for a timeline report for the Jim Smith Menu shown in FIG. 43, the screen showing a summary of the Jim Smith deal.

FIG. 45 shows the timeline report for the opening event in the Jim Smith deal.

FIG. 46 shows a timeline report screen from an event near the middle of the Jim Smith deal.

FIG. 47 shows the timeline report screen for the next event after the event shown in FIG. 46, which screen is accessed by clicking the arrow on the right side of FIG. 46.

FIG. 48 shows the timeline report for the event following the event of FIG. 47.

FIG. 49 shows the timeline report for the event following the event of FIG. 48.

FIG. 50 show the timeline report for when the down payment was updated to $1,000.

FIG. 51 shows the timeline report for a modification of the payment term.

FIG. 52 shows the timeline report for when Jim Smith signed the Menu.

FIG. 53 shows the concluding timeline report screen for the Jim Smith deal.

### DETAILED DESCRIPTION

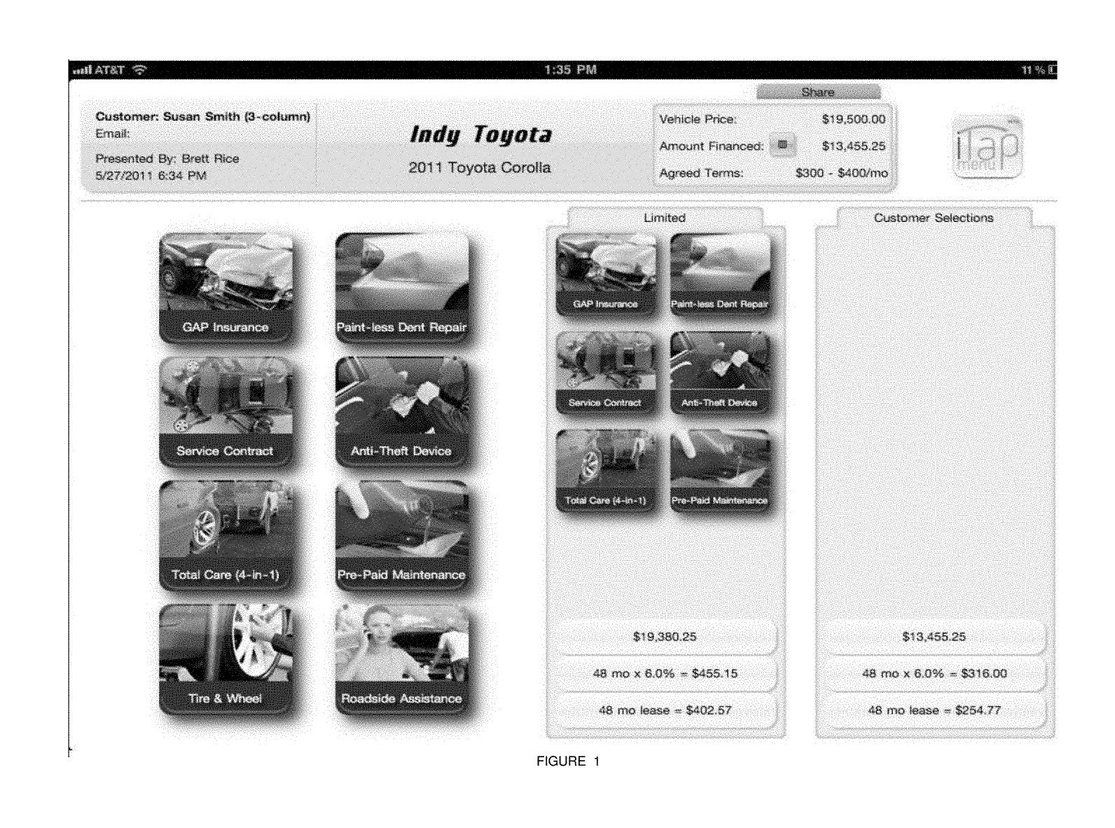

FIG. 1 shows an F&I menu system before any F&I menu items are selected, and with six recommended F&I menu items. The visual user interface has three main areas. On the left is an all-options or unselected options area displaying icons of a plurality of unselected F&I menu icons for a vehicle. Each F&I icon is associated with an F&I menu item that has a price associated with it. In the center is a predetermined subset area capable of displaying copies of a subset of the plurality of F&I menu icons. In this case, a subset of six icons for “recommended” optional items are shown. On the right is a selected options area for displaying selected F&I menu icons. In FIG. 1, the selected area is blank.

The visual display also includes three price areas. The base price area shows the base cost of a vehicle, in this case, shown as “Vehicle Price: $19,500.” This represents the price without any F&I menu items. In this embodiment, this area also shows the amount financed. The bottom of the predetermined cost display area displays the cost of the subset of the plurality of F&I menu items represented by the F&I menu icons in the predetermined subset area. In this example, six such icons are shown. The cost is expressed in three formats: total cost including the price of the vehicle, the cost assuming the car is financed over a specified term and interest rate, and the cost for monthly lease payments if the car is leased. (All costs are net of the down payment, as discussed further below). The bottom of the selected area also shows these same types of costs. However, as no F&I menu options have been selected, the vehicle cost is the same as that shown in the base price area.

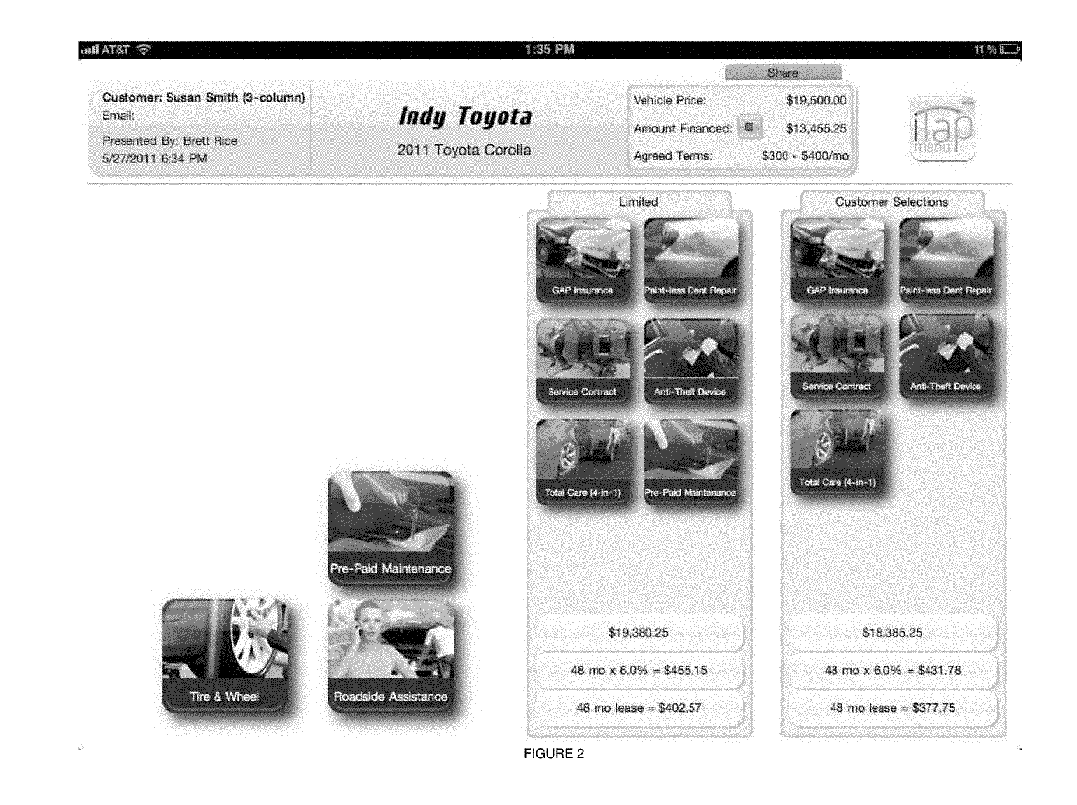

FIG. 2 shows an F&I menu system with five of 8 options selected. The selection process is described below. However, what is noteworthy is that the displayed cost of the selected F&I menu items has been instantly updated to reflect their total cost (inclusive of the vehicle). The updated prices are shown below the selected area.

It will be appreciated that the subset of the plurality of F&I menu items in the predetermined subset area remain static, as does their cost. This allows a customer to easily compare the cost of selected menu items to recommended menu items. Having the costs of recommended and selected menu items simultaneously visible, with the selected item costs being instantly updated, significantly reduces the time to select menu items, and increases the customer's satisfaction with the purchasing process.

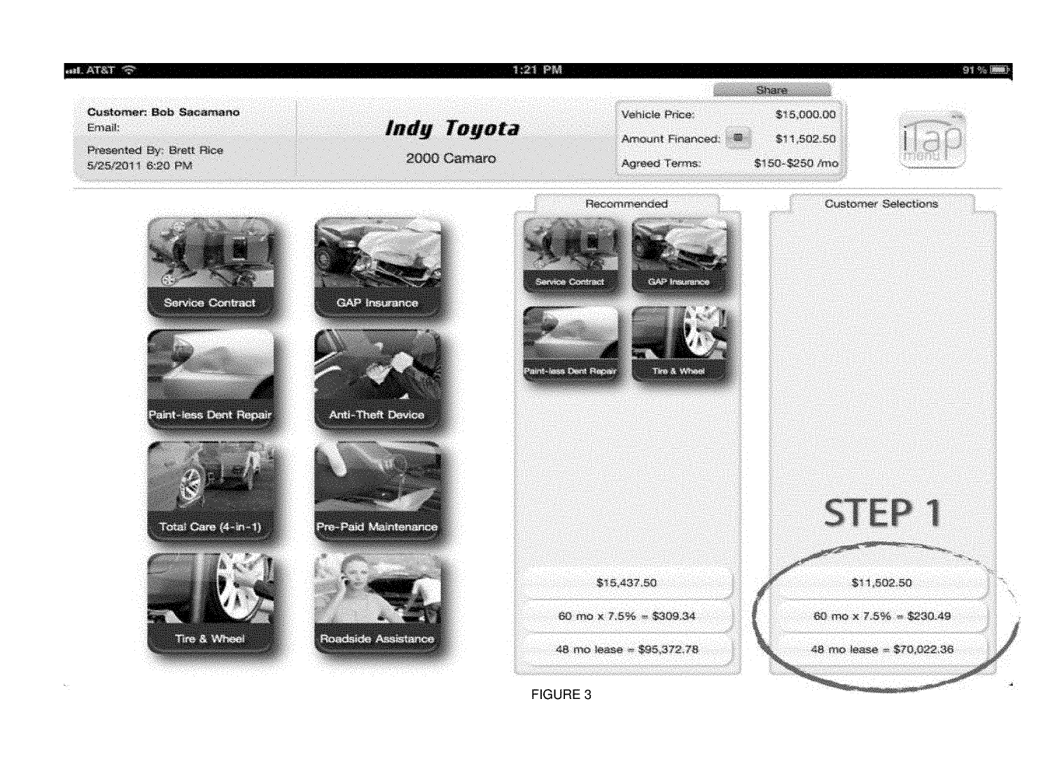

FIG. 3 shows vehicle cost information before any F&I menu items are selected. This is for a different vehicle than that shown in FIGS. 1-2. Because no F&I menu items have been selected, the costs shown as STEP 1 reflect just the vehicle (after applying the initial payment). In addition, three formats for the cost with options are shown, namely, a fixed (or up-front cash) amount; a periodic payment according to a first set of payment terms, namely a 60 month lease at 7.5% interest, or a 48 month lease.

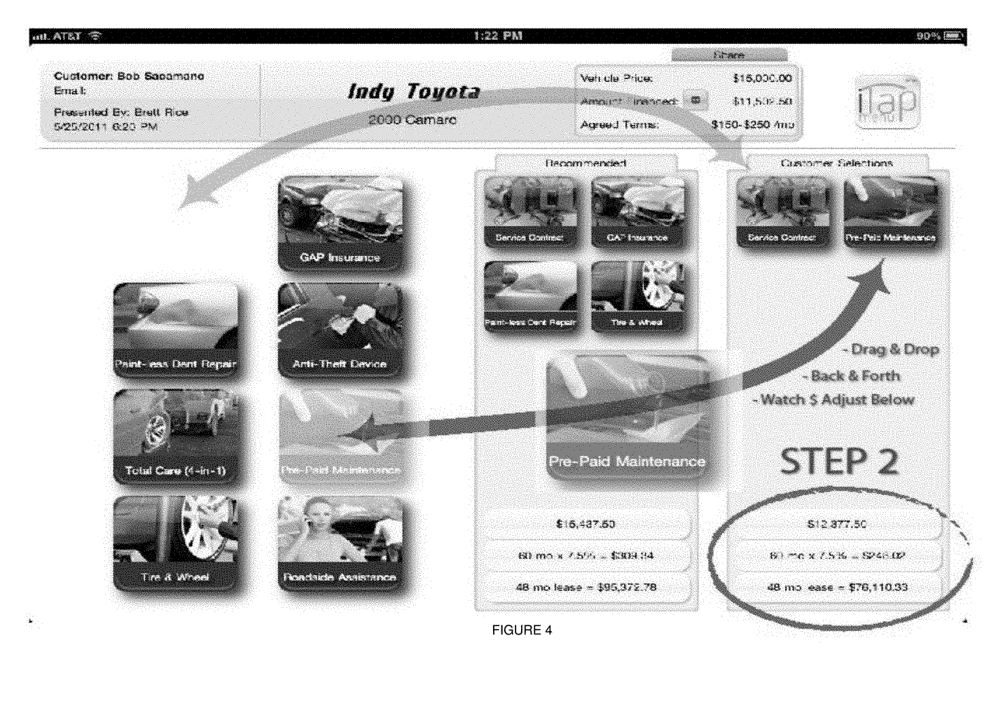

FIG. 4 shows how F&I menu items may be selected by dragging associated icons from the unselected or all-options area to the selected options display area, and how the vehicle cost information is instantly updated to reflect the selected item. The customer is free to add and remove F&I menu items as they see fit. In FIG. 4, two F&I items have been moved from the all-options area to the selected area, and the cost information has been instantly updated to reflect the two F&I menu items.

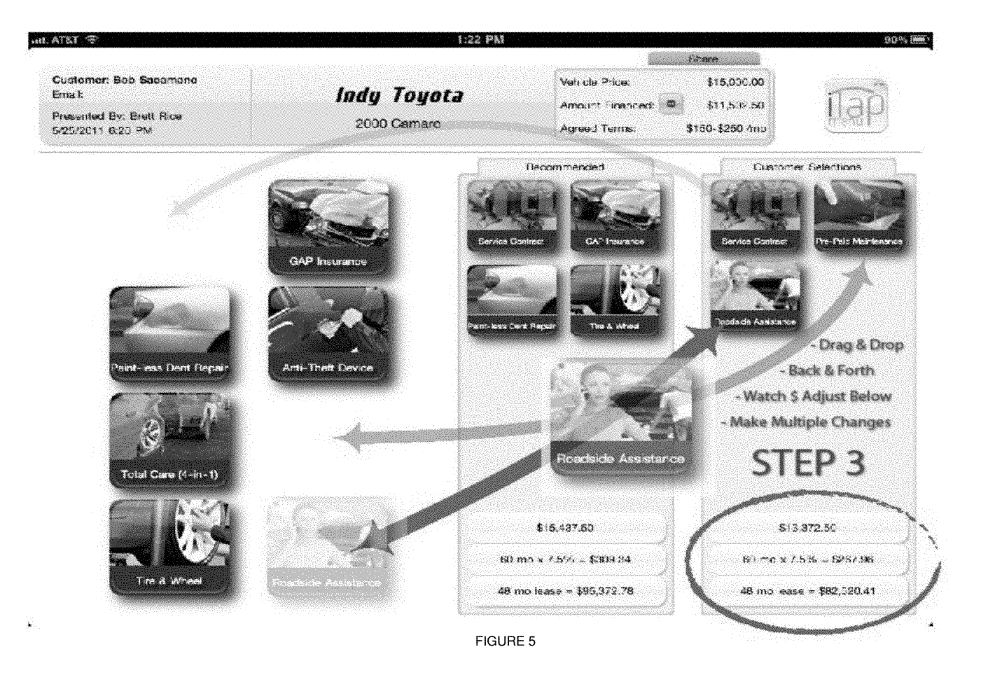

FIG. 5 shows how selecting an additional (third) F&I menu item further instantly updates the vehicle cost information. The selection of F&I menu items may be accomplished based on the capabilities of the user interface. In one embodiment, a tablet such as an Apple iPad® is used, and F&I menu items may be selected by touching and dragging them between the all-options and selected areas. However, a user interface may also provide for selections to be made using a mouse, voice command, eyeball tracking, or any form of user interface. In addition, other options for selection items instead of dragging icons may be to simply tap the icon, or to depress it for a predetermined time period, such as three seconds. For such an embodiment, a visual indicator may be made that the icon has been selected, such as by surrounding it with a colored frame. In addition, applying the same action to the icon can deselect it.

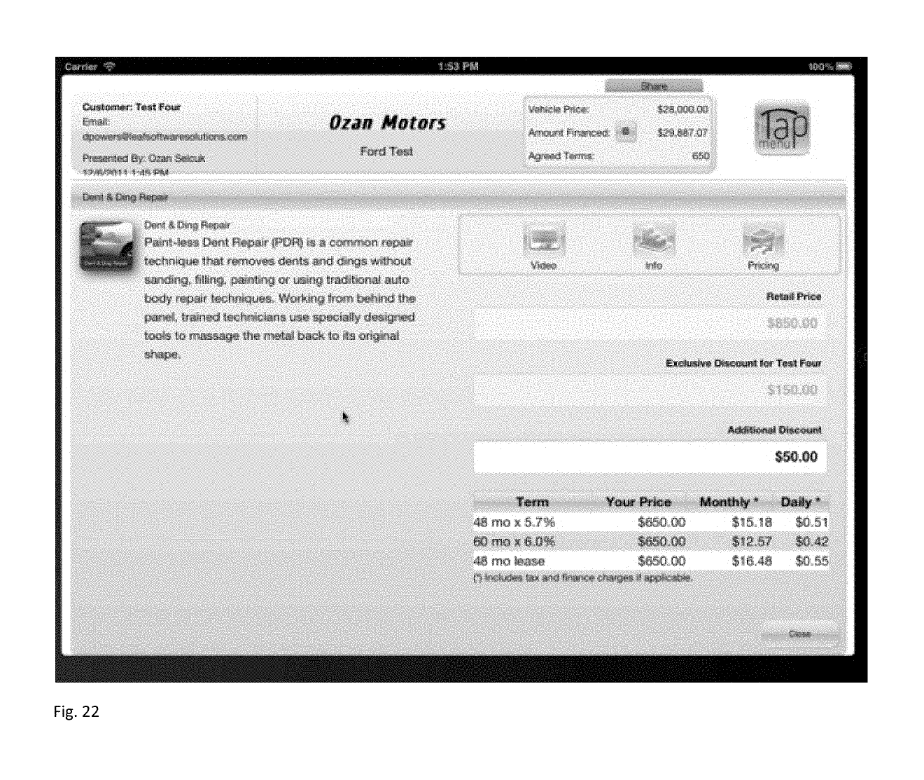

Moreover, optional item icons may be subject to different types of actions. For example, a salesperson may encounter price resistance to a customer purchasing a particular optional item. Thus, the salesperson may wish to offer the customer a “special deal,” but at the same time, not let the customer know in advance that a special deal is available. Thus, a “hidden” method for offering a special deal may be configure the icons so that if they are subject to non-evident action, such as pressing the icon continuously for 5 second, that a special screen pops up such as that shown in FIG. 22. This screen has an option for specifying an “Additional Discount” which may be factored in the cost calculations, which may result in the customer electing to purchase the optional item.

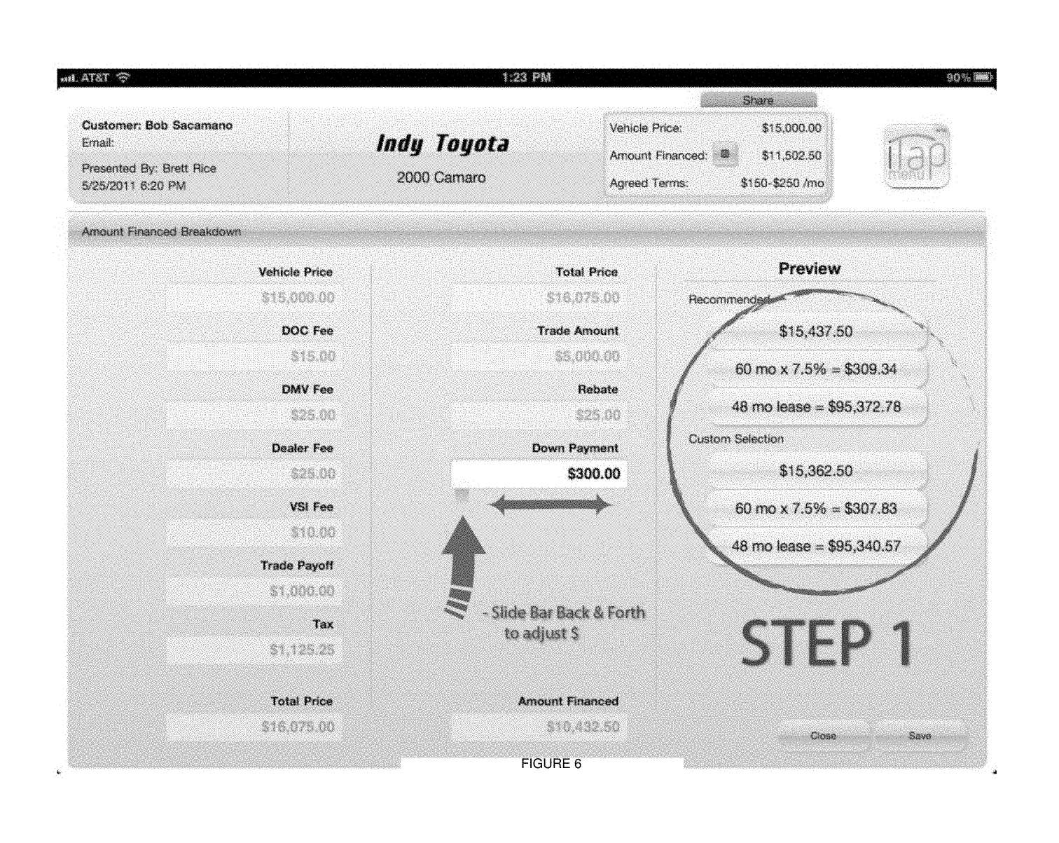

One variable for the cost in purchasing a vehicle is the amount of the initial or down payment. This may be altered by selecting the yellow button next to the “Amount Financed” on FIGS. 1-5. This displays the screen in FIG. 6, which may show basic information about the vehicle purchase. Usually, this information will have been entered into a back-end system, and the dimmed information shown in FIG. 6 (such as the vehicle price) cannot be changed via this user interface. However, one variable the customer is able to change is the Down Payment (or “initial payment”). This change may be made by use of any suitable user interface device, such as slider bar. As shown in FIG. 6, the slider bar is at the far left, and represents a minimum down payment of $300. The associated cost for Recommended and Selected F&I menu options are designated as STEP 1.

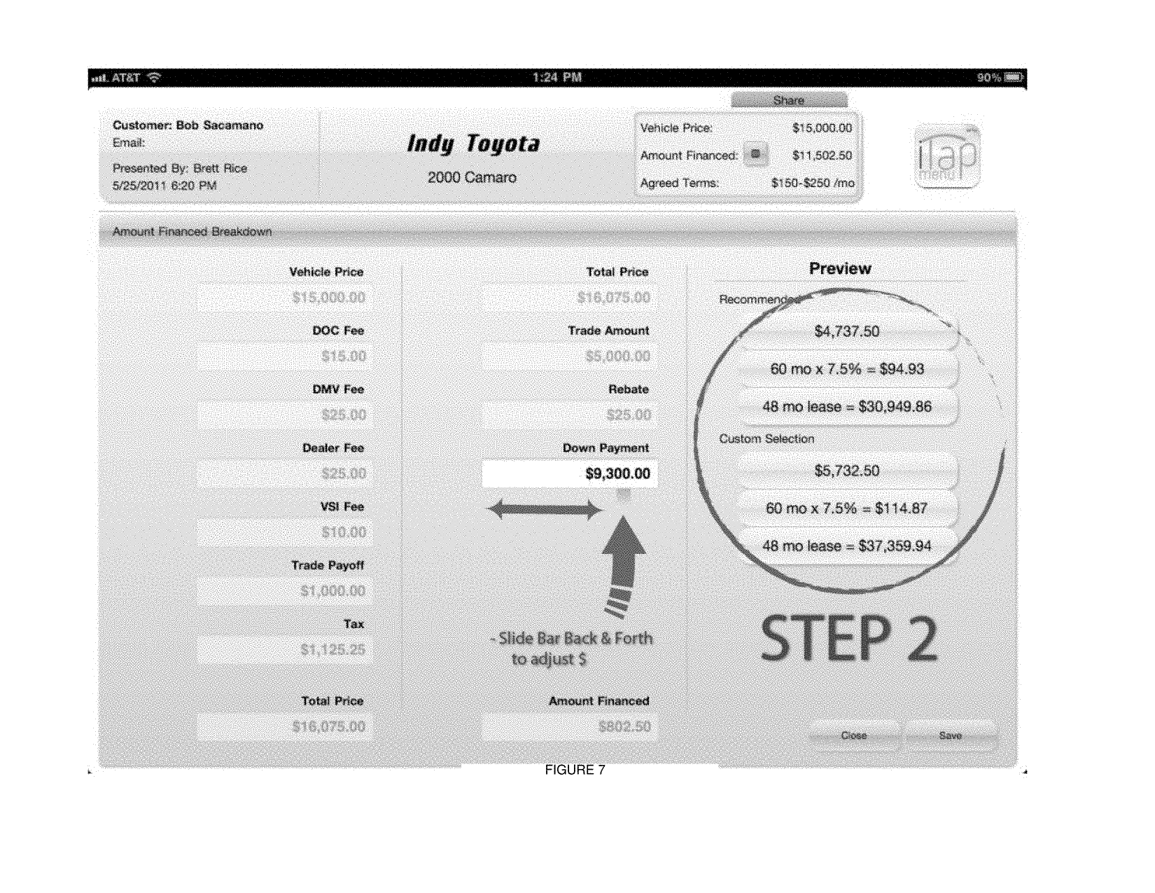

FIG. 7 shows the use of slider bar to change the amount of an initial payment, and the corresponding instantaneous change to the vehicle cost information. Here, the slider bar is moved to the right such that the initial payment is increased to $9,300. Below this amount, the Amount Financed has been decreased to $802.50, and as shown as STEP 2, the total costs for the Recommended and Selected F&I menu items have also decreased.

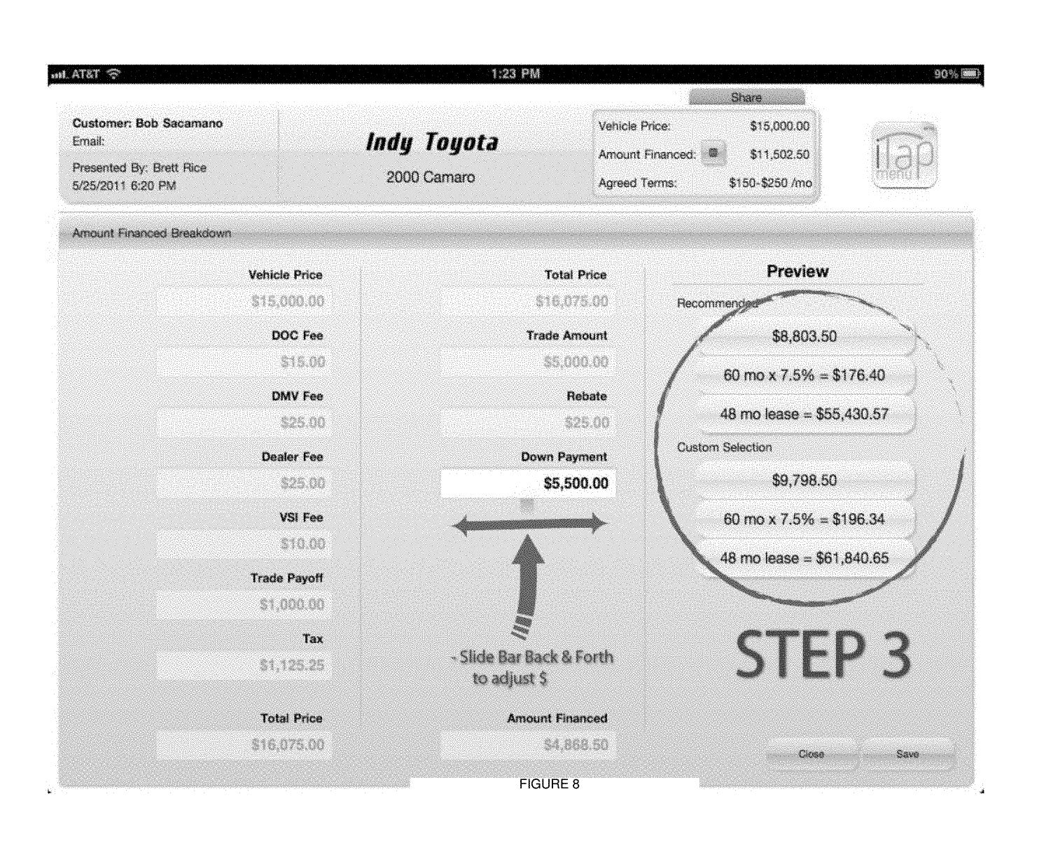

FIG. 8 shows how further alteration of the initial payment results in further instantaneous change to the vehicle/F&I menu item cost information. As will be appreciated, this down payment of $5,500 is between the down payments shown in FIGS. 6 and 7. Consequently, the F&I menu item costs shown as STEP 3 are also between those shown in FIGS. 6 and 7.

The formulas for calculating the costs of various F&I menu items and factoring periodic payments and interest are well known in the art and do not form a part of the invention per se. Some F&I menu items, such as gap insurance, may be affected by the Amount Financed, while others, such as the cost for prepaid maintenance will not. In addition, the calculations for determining finance or leasing payments are known in the art. Also, those of skill in the art will appreciate that any other user interface device for specifying a price could be used in lieu of a slider bar, such as a text input box, radio buttons, etc.

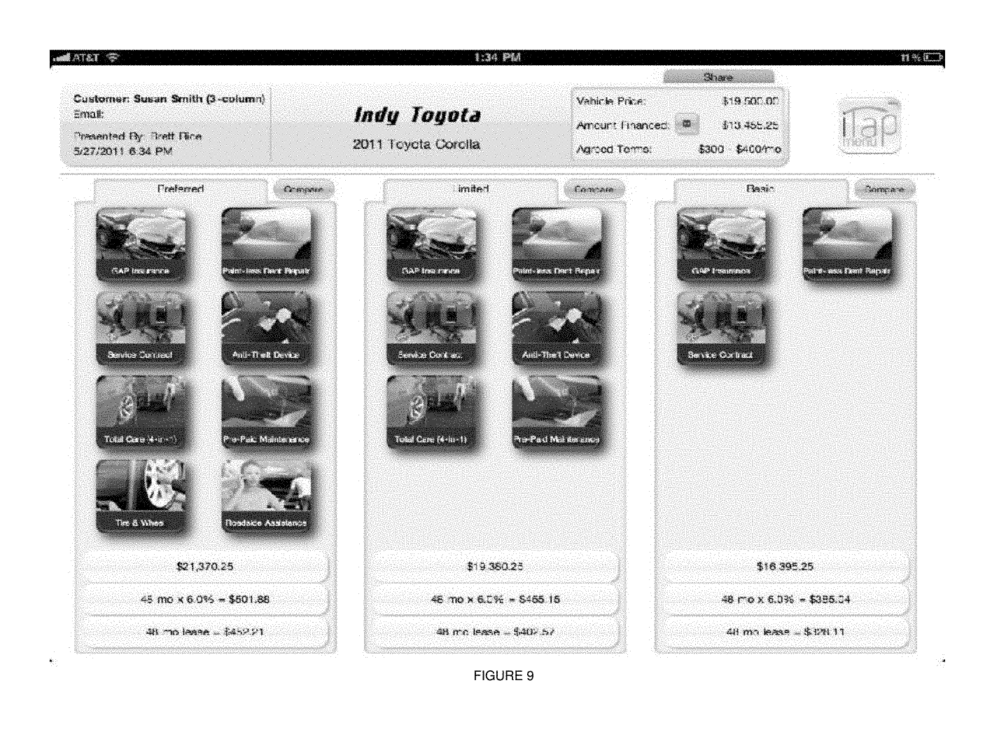

FIG. 9 shows an F&I menu system configured to display different combinations of F&I menu items, and their associated costs. For some customers, a sales person may prefer not to give a customer unlimited control of F&I menu options. Therefore, the disclosed system may include the option of specifying multiple (in this case, three) predetermined selections of F&I menu options. The price of each is shown, and the customer is not given the option to customize the offerings. This feature is particularly helpful for customers who have a difficult time making a decision. Presenting such customers with fewer options has the beneficial effect of minimizing the time required to make a final selection. Optionally, the various predetermined selections may be presented as Gold, Silver and Bronze packages, or some other designation denoting total value.

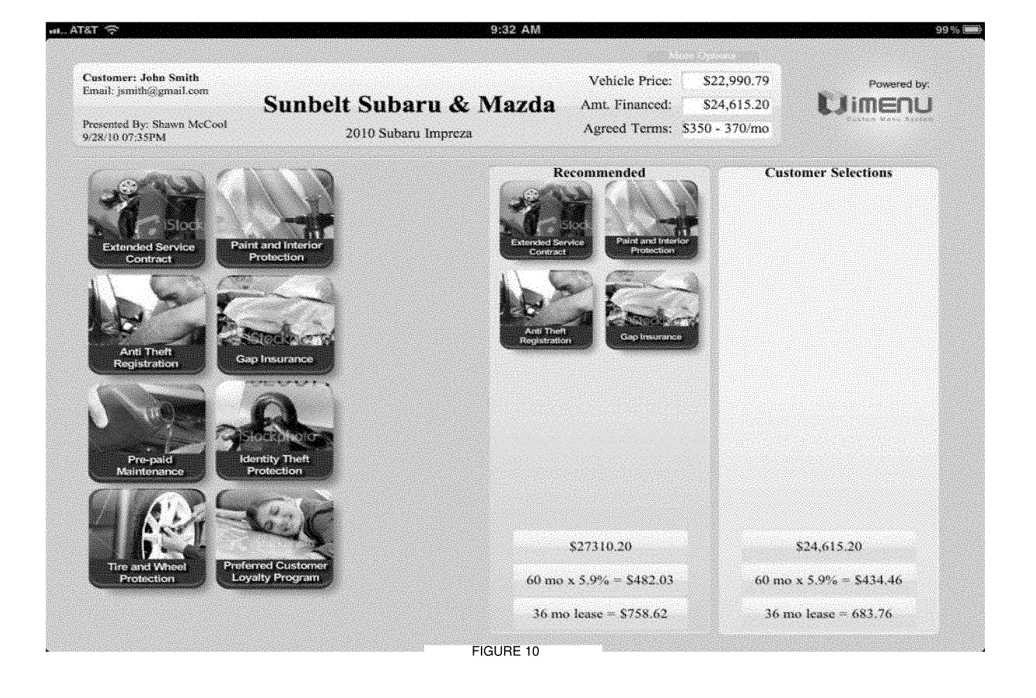

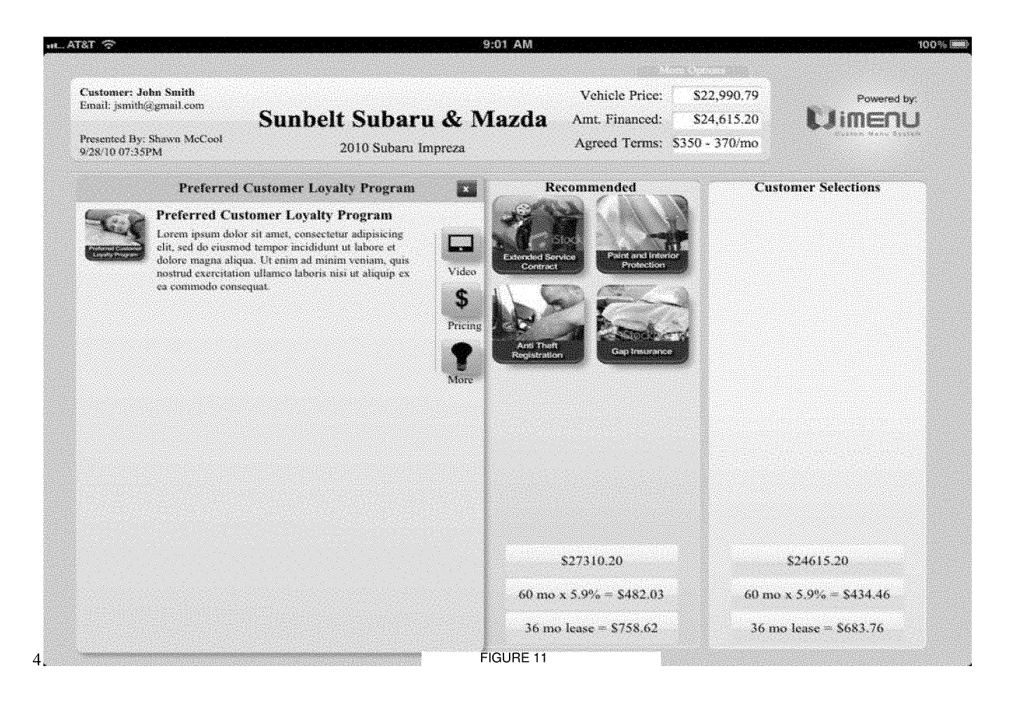

The disclosed system also includes the capability to obtain more detailed information regarding a particular F&I menu option. FIG. 10 shows another embodiment of an F&I menu system before any F&I menu items are selected. By double-tapping an F&I menu icon (or using another icon-selecting user interface method such as pressing for 5 seconds), further information may be displayed. For example, if the “Preferred Customer Loyalty Program” F&I menu icon is selected, the window shown in FIG. 11 may be displayed.

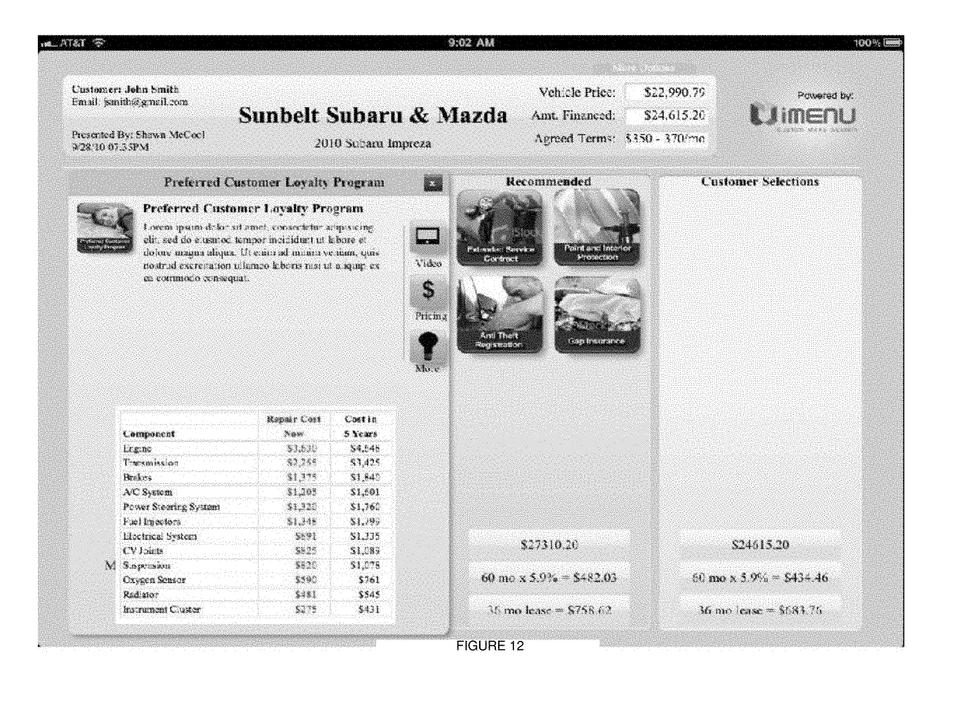

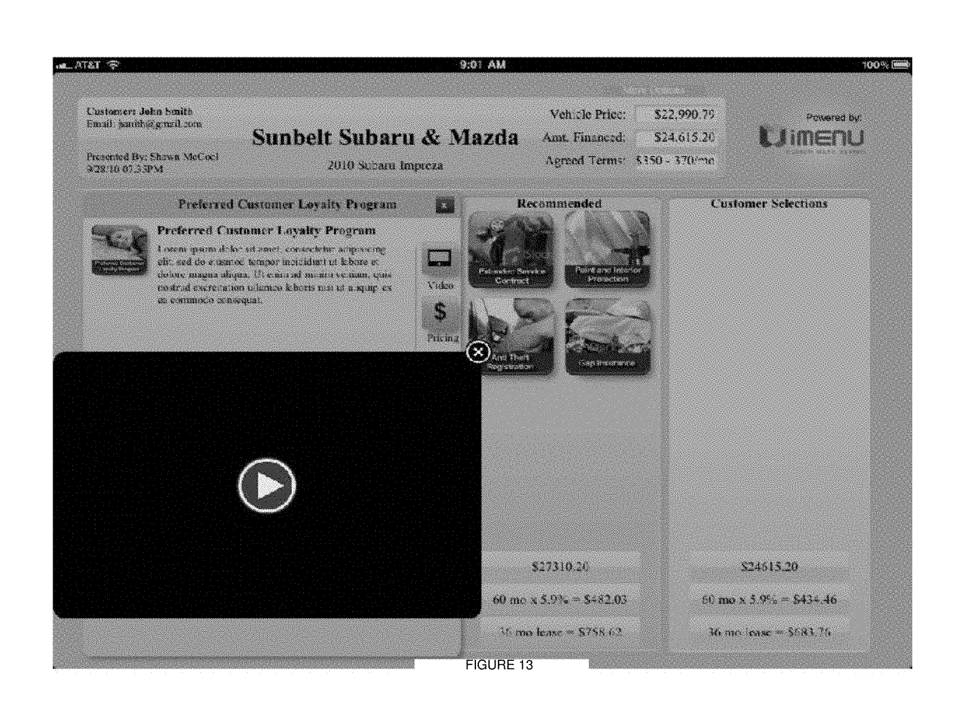

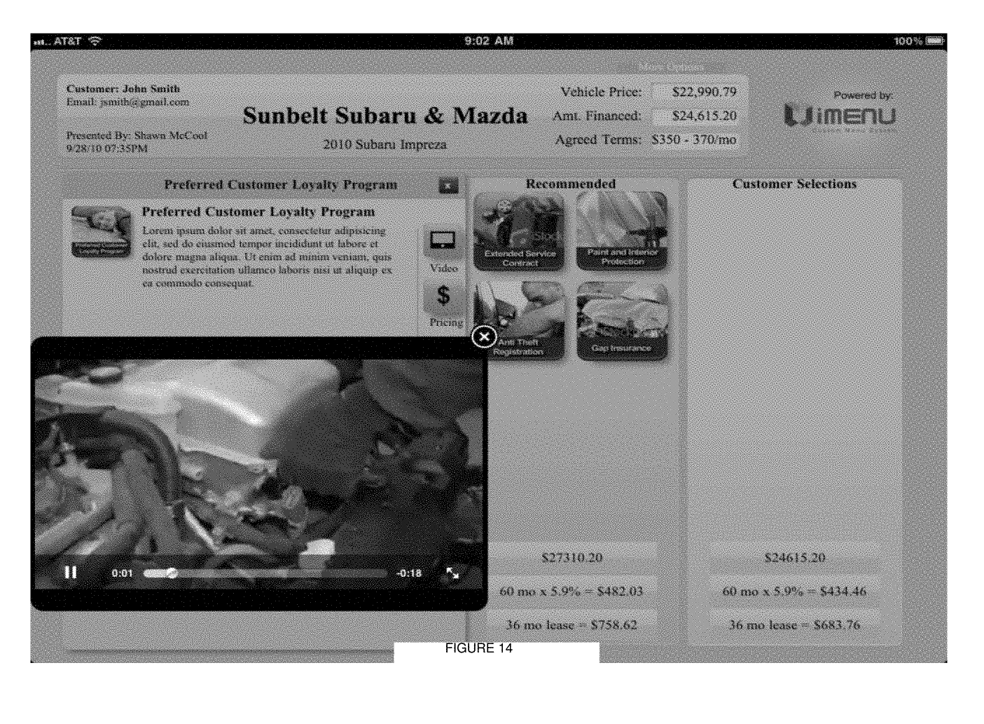

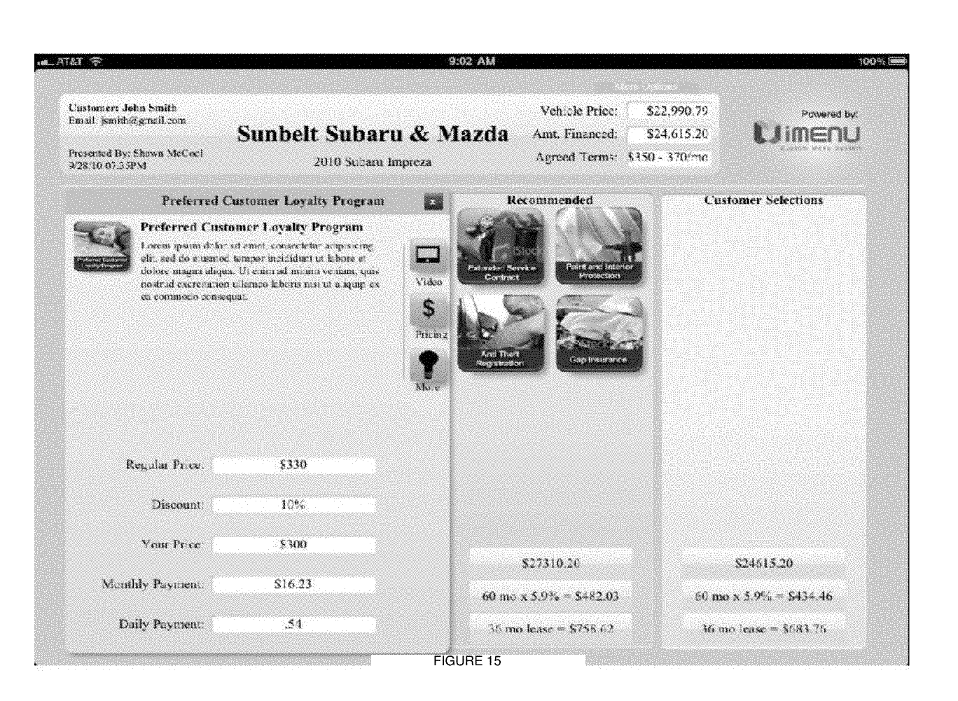

FIG. 11 shows how additional information regarding an F&I menu item may be displayed by selecting the item. In one embodiment, a brief textual description of the F&I menu item is displayed. In addition, the customer may view further information by selecting the Video, Pricing or More options. Representative embodiments for displaying this additional information are shown in FIGS. 12-15.

Systems for storing information regarding customers, product offerings and the calculation of vehicles financing terms are known in the art and not part of the present invention per se. In one embodiment, databases may be stored on the Internet (in “the cloud”) and accessed remotely via a wireless, web-based client device such as an iPad®, tablet computer or the like.

Those of skill in the art will understand that various details of the invention may be changed without departing from the spirit and scope of the invention.

As used in this specification and the claims, the term “purchase” or “purchaser” and variants thereof refers not just to a purchase, but to any other transaction in which a person may acquire use of an object via an agreement, such as by lease or rental. Also the term “icon” refers to any visual indicia, whether a picture, a graphic, or text.

As used in this specification and the claims, the term “F&I menu item” or “optional item” refers not just to a transaction involving a vehicle, but to any type of product or service that is an optional, add-on purchase item in connection with the sale, lease or rental of an underlying product. For example, in connection with the acquisition of a cell phone, F&I menu items could include extended warranty products, data access plans, roaming plans, international calling or roaming plans, loss or theft insurance, cloud or other data storage services, etc. In connection with the rental of a vehicle, F&I menu items could include damage waiver insurance, collision insurance, life insurance, additional driver privileges, pre-paid fuel refilling, GPS rental, etc. In connection with the purchase of a pizza, an F&I menu item could refer to the optional toppings of the pizza, such a sausage, pepperoni, mushrooms, etc. The key is that an F&I menu item or an optional item is always sold in connection with another underlying product, there is only an option to purchase a single instance of the F&I menu item (i.e., the “quantity purchased” is always one), and the cost of the underlying product and the F&I menu item(s) may be bundled together. Because an F&I menu item contemplates the ability to purchase only one quantity of the item, for systems, such a pizza ordering system, in which it may be desired to offer, for example, both sausage and double sausage, this may be accommodated by making these two options separate F&I menu items. In this case, if both the sausage and double sausage items were selected, the customer would in essence be ordering triple sausage.

An F&I menu icon may be selected in multiple ways, such as by: (a) dragging it from the options area to the selected area, causing it to appear only in the selected area and not the options area; (b) dragging it from the options area to the selected area, causing it to be copied to the selected area while the original remains in the options area (in which case it may be de-selected by dragging it back from the selected area to the options area, or perhaps by clicking an “X” which may be displayed on the icon in the selected area; (c) tapping or double tapping the icon, in which case a similar tapping or double tapping may de-select it; or (d) using any other icon-selecting technique which are known in the art.

In the embodiments shown in the drawings, the all-options, predetermined (or recommended) and selected areas are mutually exclusive and each is contiguous. However, it is within the spirit and scope of the invention that such areas may be noncontiguous. For example, a user interface may be utilized in which an F&I icon is selected, by either some means other than dragging to the selected area, such as by tapping (but not moving) the F&I icon (e.g., when tapped, a yellow ring may light up to surround the F&I icon, while tapping again de-selects the icon). In such an implementation, when the F&I icon lights up, the space it occupies on the screen would automatically become a part of the “selected” area, and the cost options would be automatically be updated to include the cost inclusive of the selected F&I menu item.

Moreover the system may wirelessly save transactions in a database, allowing them to be reflected on the dealer's inventory and F&I performance reporting.

The term “base cost” refers to a cost without any F&I menu items. Depending on the implementation, the base cost may either include or exclude various ancillary costs such as taxes on the vehicle, delivery and preparation fees, etc. However, the base cost will not include additional cost of any of the optional F&I menu options/items.

As discussed above, one embodiment of the invention includes the simultaneous display of a base price/cost without any optional items, and with optional items. Moreover, it may be desirably to instantly and automatically update the cost with optional items as they are selected, whether the selection is done by dragging icons to a selected options area, or by some other technique such as by highlighting or un-highlighting an icon each time it is tapped, when the icon is touched for a predetermined time period, such as 3 seconds. A means for automatically updating the base cost of the product with options as item icons are selected may be accomplished through software. Representative software for performing such updating using a drag and drop methodology is:

Code executed when an item is dragged to a selected options area:

```
customLocationDropped: function (r, e) {
      e.preventDefault( );
      e.stopPropagation( );
      var $product = $(r);
      var $customLocation = this.elements.customLocation;
      this.elements.customProductList.append($product);
      $product.attr(‘style’, ‘’).removeClass(‘origin’).addClass(‘custom’);
      var repo = page.repo.productRepo;
      var product = repo.all
            .where(‘MenuProductId’, ‘=’, $product.attr(‘id’))
            .and(‘Available’, ‘=’, true).single( );
      product.Custom = true;
      if (repo.save(product) == 1) {
            page.laneCalculator.update_all( );
      }
}
```

Code executed when an item is dragged out of a selected options area:

```
originLocationDropped: function (r, e) {
      e.preventDefault( );
      e.stopPropagation( );
      var $product = $(r);
      var $customLocation = this.elements.customLocation;
      this.elements.menuProductList.append($product);
      $product.attr(‘style’, ‘’).removeClass(‘custom’).addClass(‘origin’);
      var repo = page.repo.productRepo;
      var product = repo.all
            .where(‘MenuProductId’, ‘=’, $product.attr(‘id’))
            .and(‘Available’, ‘=’, true).single( );
      delete product.Custom;
      if (repo.save(product) == 1) {
            page.laneCalculator.update_all( );
      }
}
```

Code executed to update base cost with options displayed in the with-options area:

```
views = namespace ‘menu.presentation.views’
clone = (obj) ->
  if not obj? or typeof obj isnt ‘object’
    return obj
  newInstance = new obj.constructor( )
  for key of obj
    newInstance[key] = clone obj[key]
  return newInstance
class Lane
      constructor: (parent, name, terms) ->
            @parent = parent
            @lowerName = name
            @name = @upperCaseFirstChar name
            @terms = (clone term for term in terms)
            @financeInfo = page.model.financeInfo
            @productRepo = page.repo.productRepo
            @formatter = menu.presentation.domain.model.TermOptionFormatter
            @discountLabel = $(‘.discount.label’, @parent)
      draw: ->
            products = @products( )
            @updateDisplay term, @monthlyPaymentFor(products, term) for term in @terms
            @updateDiscountLabel( );
            return
      updateDiscountLabel: ->
            @discountLabel.css ‘visibility’, ‘visible’ if
(page.model.columnDiscounts[@lowerName] ? 0) > 0
            @discountLabel.css ‘visibility’, ‘hidden’ if
(page.model.columnDiscounts[@lowerName] ? 0) is 0
            discount = $.global.format @discount( ), ‘p’
            amount = $.global.format @discountAmount( ), ‘c’
            @discountLabel.text “#{discount} discount (#{amount} savings)”
      monthlyPaymentFor: (products, term) ->
            lastPayment = 0
            idx = 0
            @resetCreditInsuranceProduct product for product in products when
product.EditorTypeId is 2
            while idx < 6 or lastPayment is not payment
                  lastPayment = payment
                  payment = @_monthlyPaymentFor products, term
                  idx++
            payment
      _monthlyPaymentFor: (products, term) ->
            payment = @financeInfo.MonthlyPaymentFor products, term, @discount( )
            balloon = (t) => @financeInfo.BalloonPaymentFor products, t, @discount( )
            @calculatePaymentWithCreditInsurance payment, term, balloon
            @financeInfo.MonthlyPaymentFor products, term, @discount( )
      resetCreditInsuranceProduct: (product) ->
            product.RetailPrice = 0
            product.YourPrice = 0
            return
      calculatePaymentWithCreditInsurance: (payment, term, balloon) ->
            group = (@products( ).filter (product) -> product.IsGroup)[0]
            if group && term.TermTypeId isnt 1
                  settings = new views.CreditInsuranceSettings( )
                  settings.createLane @lowerName unless settings.exists @lowerName
                  products = settings.productsFor @lowerName
                  laneGroup = settings.groupFor @lowerName
                  @updateProductPrice payment, product, term, balloon for product in
products
                  group.RetailPrice = 0
                  group.RetailPrice += product.RetailPrice for product in products
                  group.YourPrice = group.RetailPrice
                  laneGroup.RetailPrice = group.RetailPrice
                  laneGroup.YourPrice = group.YourPrice
      updateProductPrice: (base, product, term, balloon) ->
            product.RetailPrice = 0
            Product.YourPrice = 0
            if product.CreditInsuranceInformation.IsAvailable
                  ci = product.CreditInsuranceInformation
                  interpolator = new views.CreditInsuranceInterpolator page.model.factors
                  termForCalc = clone term
                  termForCalc.Term = Math.min (ci.Term ? term.Term), term.Term
                  termForCalc.AmortizationPeriod = term.Term unless
term.AmortizationPeriod
                  #console.log ‘term ->’, termForCalc
                  factor = interpolator.getFactor product.TPAProductId, ci.SubCodeId,
termForCalc.Term
                  if factor
                        coverage = if parseInt(ci.CoverageId) is 2 then 1.8 else 1
                        if term.TermTypeId is 3
                              tax = 0
                        product.RetailPrice = base * (termForCalc.Term − 1) *
(factor / 100) * coverage
                        if ci.CoverResidual
                              level = interpolator.getLevelFactor
product.TPAProductId, ci.SubCodeId, termForCalc.Term
                              if level
                                    console.log ‘level’, term
                                    console.log term.Residual * (level / 100)
                                    product.RetailPrice += term.Residual *
(level / 100)
                        if product.TaxOverride
                              tax = product.RetailPrice * product.TaxOverride
                              product.RetailPrice += tax
                        #console.log “(#{base} * #{termForCalc.Term−1} *
(#{factor} / 100) * #{coverage}) = #{product.RetailPrice}”
                  else
                        product.RetailPrice = base * termForCalc.Term * (factor /
100) * coverage
                        if termForCalc.AmortizationPeriod
                              level = interpolator.getLevelFactor
product.TPAProductId, ci.SubCodeId, termForCalc.Term
                              if level
                                    balloonPayment = balloon termForCalc
                                    #console.log “#{product.RetailPrice} +
(#{balloonPayment} * (#{level} / 100)”
                                    additional = balloonPayment * (level / 100)
                                    #console.log “#{product.RetailPrice} +
#{additional} = ” + (product.RetailPrice + additional)
                                    product.RetailPrice += additional if
additional > 0
                  product.YourPrice = product.RetailPrice
                  product.Cost = product.RetailPrice
      updateDisplay: (term, payment) ->
            $(“li[id=#{term.Id}]”, @parent).text(@formatter.formatFor(term, payment))
      discount: ->
            page.model.columnDiscounts[@lowerName] ? 0
      discountAmount: ->
            amount = 0
            amount += product.YourPrice for product in @products( )
            amount * @discount( )
      products: ->
            @productRepo.all.where(@name, ‘=’, true).and(‘Available’, ‘=’, true).list( )
      upperCaseFirstChar: (word) ->
            word.charAt(0).toUpperCase( ) + word.slice 1
      replaceTerm: (newTerm) ->
            @clone newTerm, term for term in @terms when term.Id is newTerm.Id
            return
      clone: (src, dest) ->
            dest[prop] = src[prop] for prop of src
            return
class LaneCalculator
      bind_all: ->
            parents = $(‘ul.termOptions’).closest(‘.lane’).parent( ).toArray( )
            @lanes = (new Lane parent, parent.className, page.model.terms[0...] for parent
in parents)
            @
      update_all: ->
            lane.draw( ) for lane in @lanes
            @
      update_term: (newTerm, laneName) ->
            lane.replaceTerm newTerm for lane in @lanes if laneName is undefined
            lane.replaceTerm newTerm for lane in @lanes when lane.name is
lane.upperCaseFirtChar laneName if laneName isnt undefined
            @
      termFor: (lane, termId) ->
            lane = @laneFor lane
            (lane.terms.filter (t) -> t.Id is termId)[0]
      laneFor: (laneName) ->
            (lane for lane in @lanes when lane.name is lane.upperCaseFirstChar laneName if
laneName isnt undefined)[0]
views.LaneCalculator = LaneCalculator
```

Calculator Code that performs each calculation step:

It is further contemplated that a displayed cost of a product, both with and without optional items, may be displayed in multiple formats. As such the “cost” may be interpreted to include or exclude interest. In additional the “base” cost may be displayed in a number of different formats, such as an up-front payment, or monthly periodic payment, or a combination of both. In addition, cost may be expressed under a variety of different financing options. For example, as shown in FIG. 22, the system may be configured for a financing option of 48 months at 5.7% interest, or 60 months at 6.0%, or for a 48 month lease. Any or all of these may be displayed, and all may be simultaneously updated of optional items are selected or deselected.

The present F&I menu system may also include a feature that suppresses display of a particular area of the F&I menu display until an icon or F&I menu item has been selected from a displayed area (e.g. the base display area or the recommended display area) of the F&I menu. Once an icon is selected, the suppressed display area is then shown along with the selected icon. Additional icons may be selected and added to the displayed selection area. Selected icons may also be de-selected or removed from the displayed selection area.

Additionally, features, terms and/or options may also be displayed within the now displayed selection area. These include financial parameters, options or other information associated with the icons in the displayed selection area. Suppressing the display of a particular area allows a sales person to focus a customer's attention to one particular area in order to promote the F&I menu items in the displayed area(s).

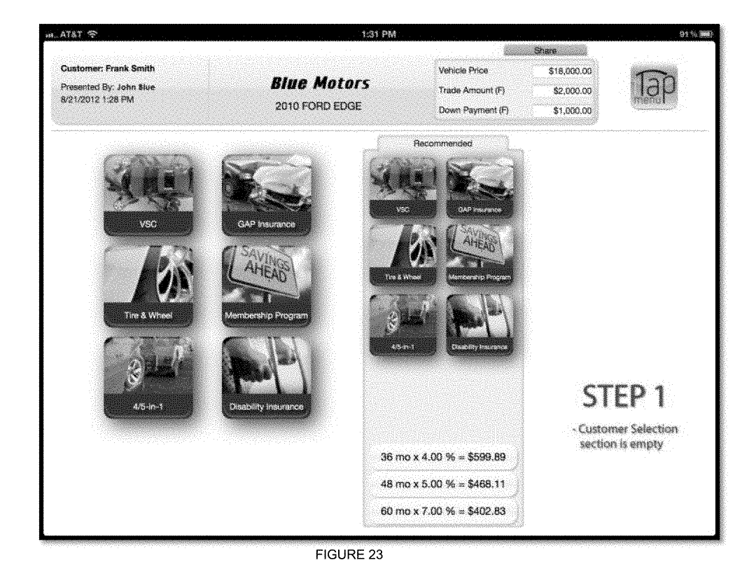

Referring to FIGS. 23-27 the suppression feature and the manner in which the feature operates is illustrated. In FIG. 23, labeled as Step 1 of the method, the F&I menu system displays a base area where all icons/products are shown, a recommended area where all of the previously selected icons/products are displayed, along with a blank area where display of a selection area is suppressed. Financial terms are displayed in the recommended area pertaining to the base cost of the product and the icons/products displayed in the recommended area. Base financial parameters are displayed at an upper section of the F&I menu system.

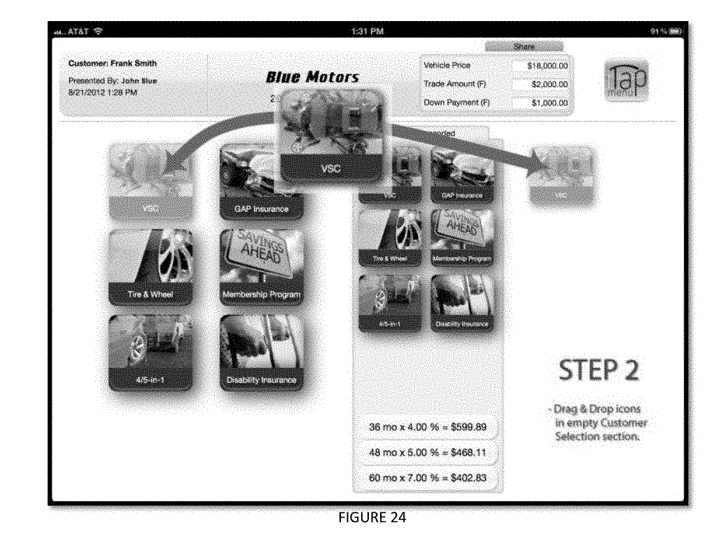

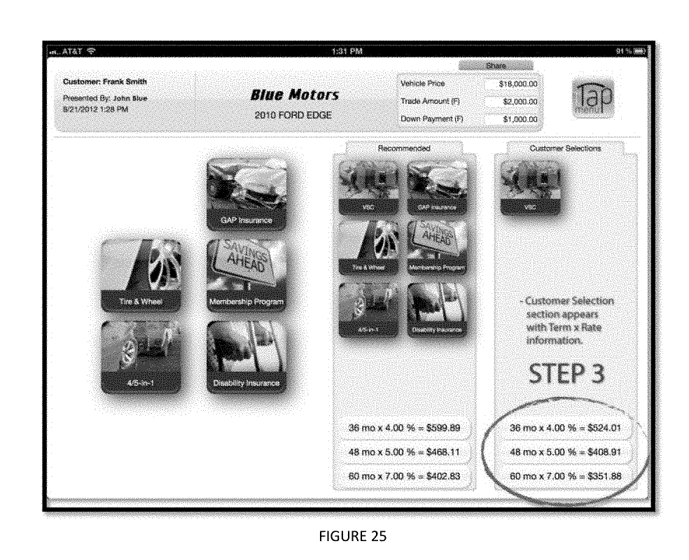

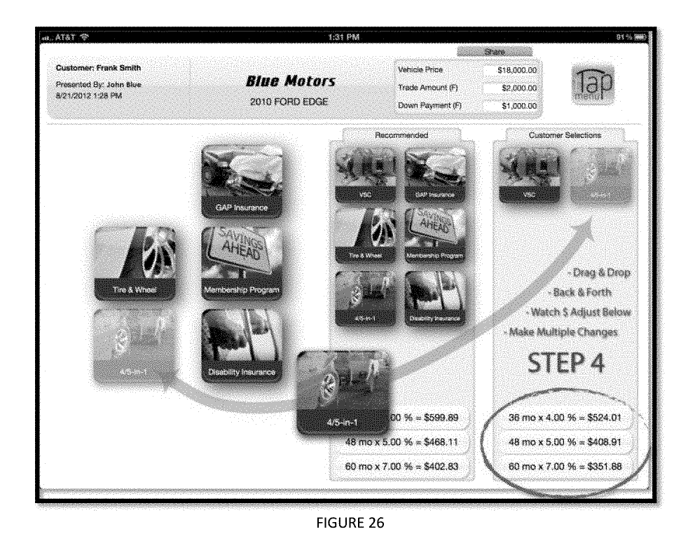

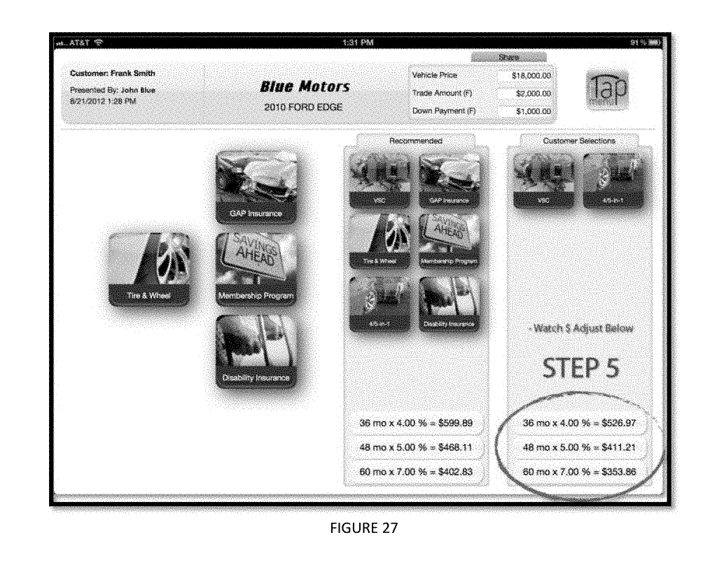

In FIG. 24, labeled Step 2 of the method, an icon is shown being selected from the base area and dragged into the blank area where display of the selection area has been suppressed. In FIG. 25, labeled Step 3 of the method, the selection area is now displayed in response to the selection of an icon. The selected icon is also displayed in the selection area along with financial terms regarding the base cost of the product and the selected icon. In FIG. 26, labeled as Step 4 of the method, icons can be selected and de-selected (moved into and out of the selection area) as desired. As icons are selected into and de-selected from the selection area, the financial terms update as appropriate. In FIG. 27, labeled as Step 5 of the method, the final selection of icons is shown along with final updated financial terms.

The F&I menu system may also provide one or more pop-up editors for adjusting a term or option of the F&I menu such as a price or finance term within a price/finance area such as the financial terms of the recommended area and the selection area of FIGS. 23-27. A pop-up editor is activated through a touch, hold and release feature. When a user touches and holds the term or option for a given amount of time, then releases the term or option (preferably, but not necessarily after visual, audio or other feedback is provided), an editor screen opens that allows editing of the term or option. In the case of a finance term or option, a finance editor screen would open that allows editing of finance rate and finance term. This allows the seller to negotiate with the consumer by modifying the financial parameters like interest rate, term, down payment and even the price of a product in order to sell all recommended products. The purpose is to sell all of the products in the recommended area (i.e. package). If the consumer balks, the seller and customer may create a custom product selection package via the selection area.

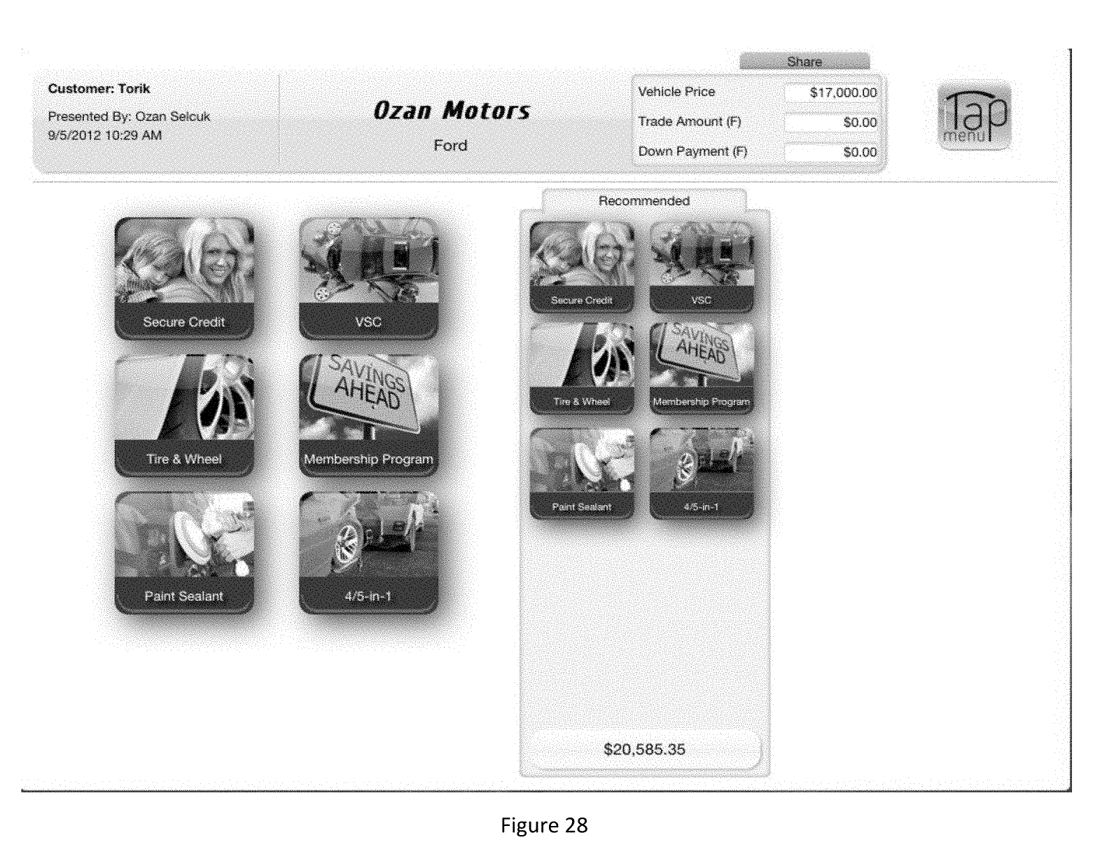

Referring to FIG. 28, there is shown an F&I menu system configured to display all F&I menu items on the left (e.g. an all-options area) and six recommended F&I menu items in a center area (e.g. a recommended area) while suppressing display of a right area (e.g. a selected options area) for displaying selected F&I menu icons once display suppression ceases. The left area displays icons of a plurality of unselected F&I menu icons for a vehicle. Each F&I icon is associated with an F&I menu item that has a price associated with it. In the center is a predetermined subset area capable of displaying copies of a subset of the plurality of F&I menu icons. In this case, a subset of six icons for “recommended” optional items are shown. Since an F&I menu item has not been selected for the right or selected options area, display of that area is suppressed.

The visual display of FIG. 28 also includes three price areas. The vehicle price area shows the cost of a vehicle, in this case, shown as “Vehicle Price: $17,000.” This represents the price without any F&I menu items. In this embodiment, this area also shows the trade-in amount, if any, and in this case, shown as “Trade Amount $0.00”, the down payment amount, if any, and in this case, shown as “Down Payment $0.00”. The bottom of the recommended display area displays the total cost given the F&I menu items represented by the F&I menu icons in the recommended area, the vehicle price, any trade-in amount, and any down payment.

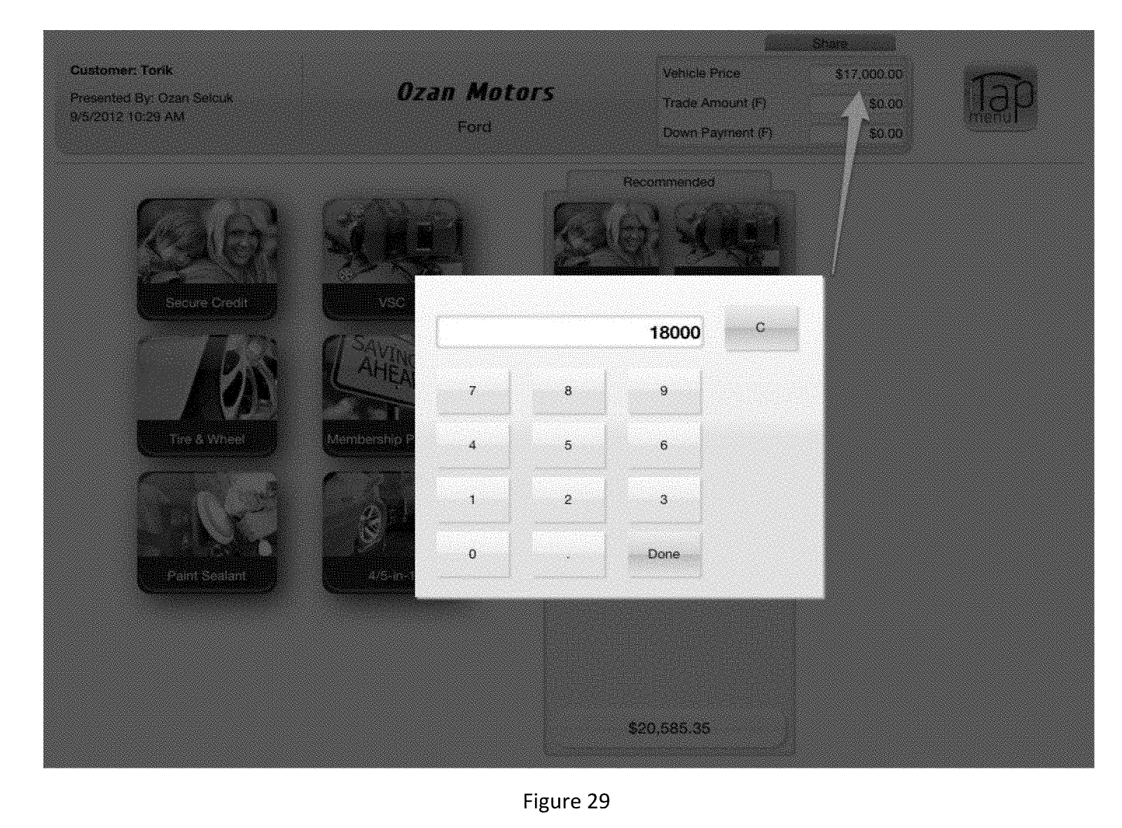

FIG. 29 shows a vehicle price editor that has been launched by manipulating the Vehicle Price text box or area. One manner of manipulating the Vehicle Price text box is by touching and holding the Vehicle Price text box for a given amount of time, then releasing the Vehicle Price text box. When the vehicle price editor pops up, the vehicle price may be changed as appropriate. In this case, the Vehicle Price has been changed to “$18,000”. Pressing or selecting “Done” in the vehicle price editor closes the editor. This method of launching editors may also work for other text boxes or areas. For instance, manipulating the Trade Amount text box or area in like manner as the Vehicle Price text box launches a trade amount editor where trade amount may be edited. Likewise, manipulating the Down Payment text box or area in like manner as the Vehicle Price text box launches a down payment editor where down payment amount may be edited.

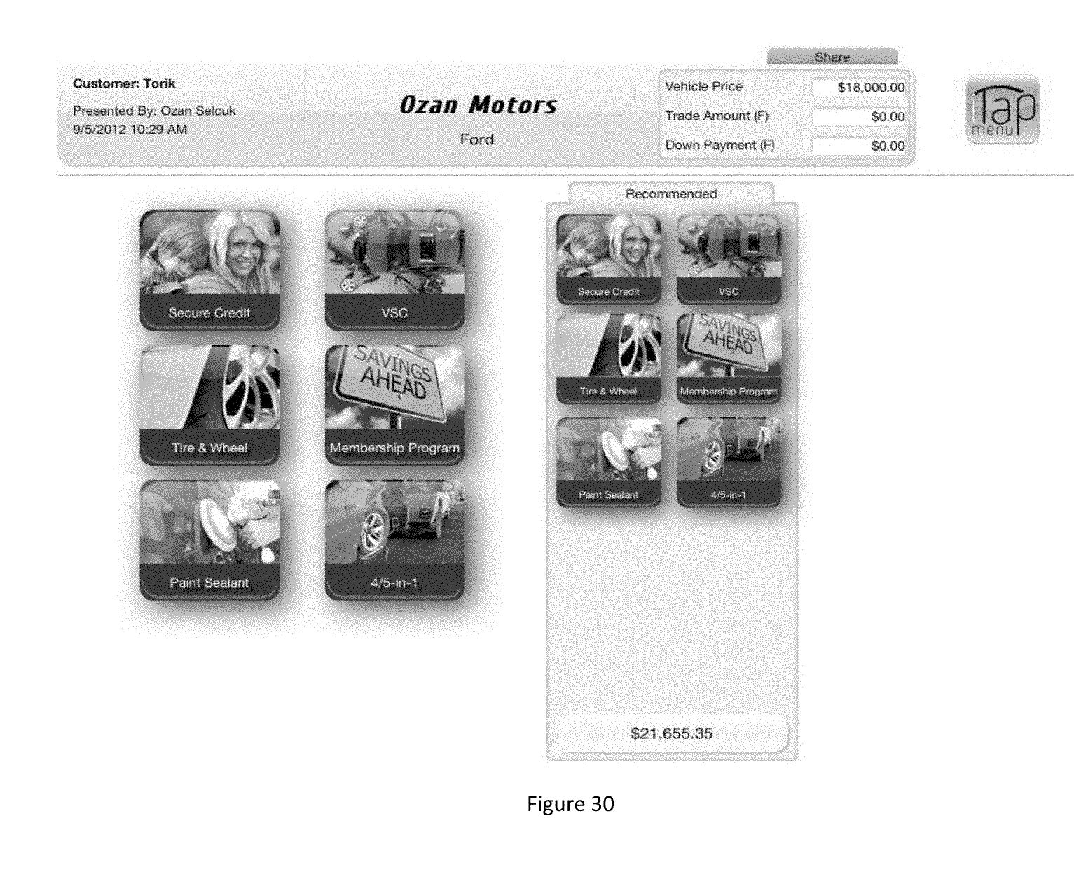

FIG. 30 shows the F&I menu after editing the vehicle price. The Vehicle Price has been updated to show “$18,000”. The total cost of the vehicle and recommended options of the recommended options area has also been updated to “$21,655.35” due to a change in vehicle price.

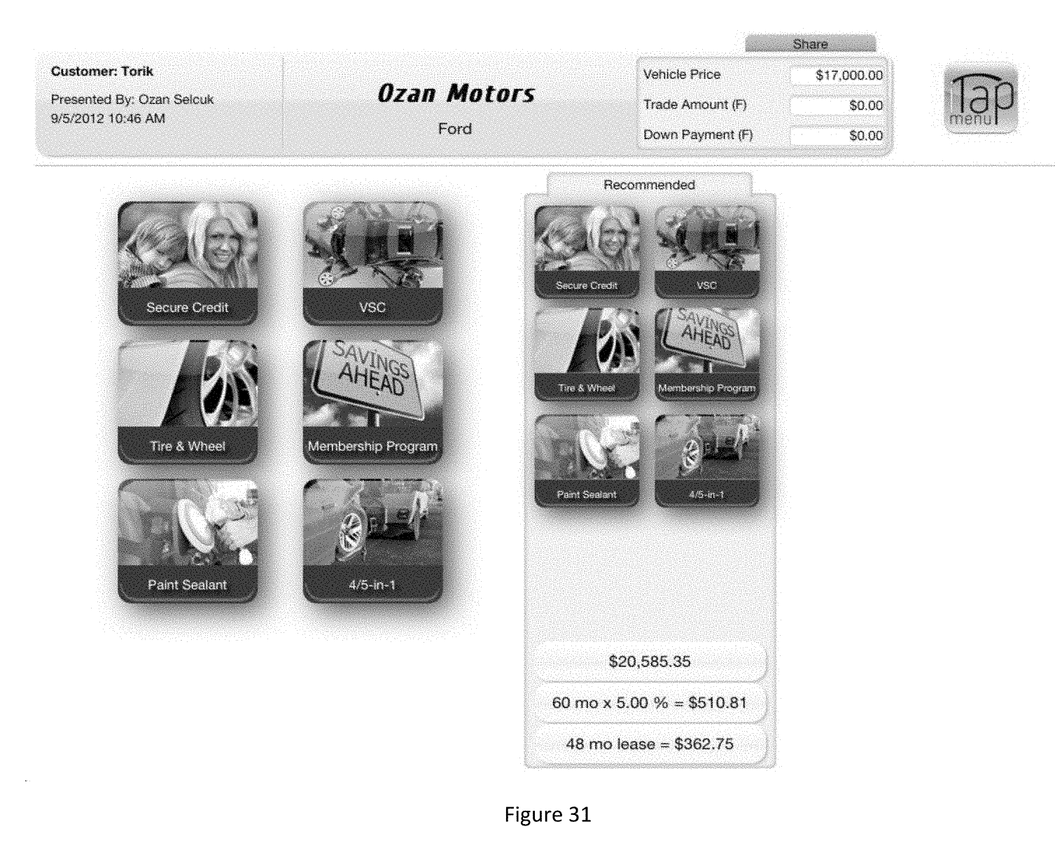

FIG. 31 shows the F&I menu as presented in FIG. 28 with the selected options area suppressed, but with three text boxes or areas displaying finance term options within the recommended options area. The top text box is total cost of the purchase. The middle text box provides finance terms and a lower text box provides a lease option. In order to open or launch a finance term options editor, the user manipulates a finance term box. A manner of manipulating a finance term box is by touching and holding the finance term text box for a given amount of time, then releasing the text box when the text box or button wiggles or provides other feedback to the user. When the finance term options editor pops up, finance terms may be changed as desired.

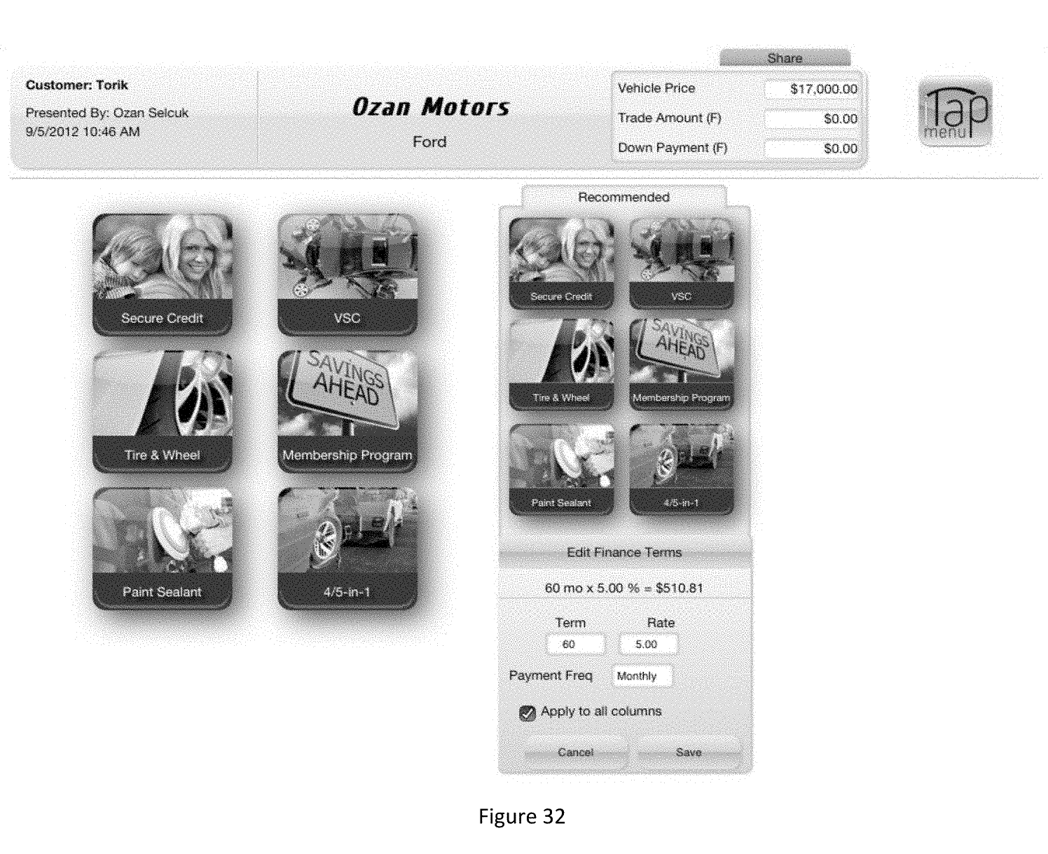

FIG. 32 shows the finance term options editor screen within the recommended options area. The finance term options editor appears on whichever text box or column the user activates it from. The user has the ability within the finance term options editor to modify terms and apply it to one text area or column or all columns. Modifications can be canceled by selecting the “Cancel” button while modifications can be saved by selecting the “Save” button.

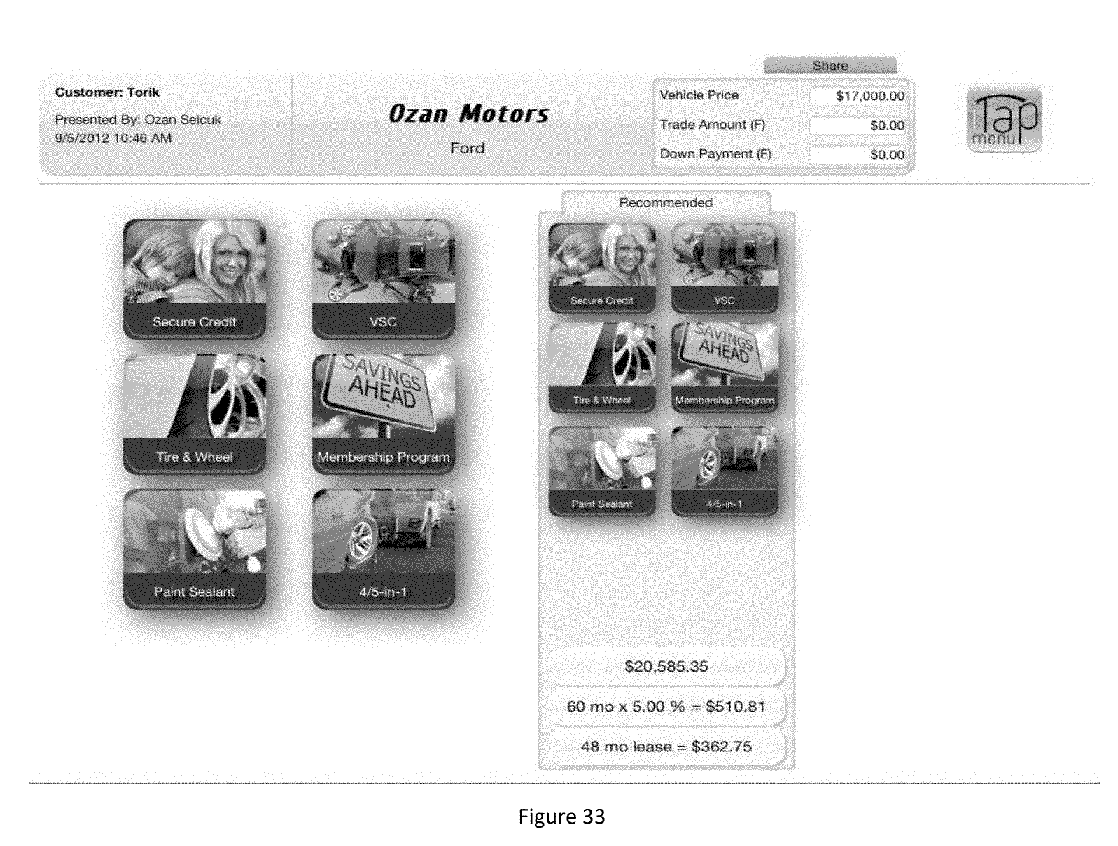

FIG. 33 shows the F&I menu as presented in FIG. 31 with the selected options area suppressed but with the with three text boxes or areas displaying finance term options within the recommended options area within the recommended options area. In order to open or launch a lease term option editor, the user manipulates the lease term box. A manner of manipulating the lease term box is by touching and holding the lease term text box for a given amount of time, then releasing the text box when the text box or button wiggles or provides other feedback to the user. When the lease term option editor pops up, lease terms may be changed as desired.

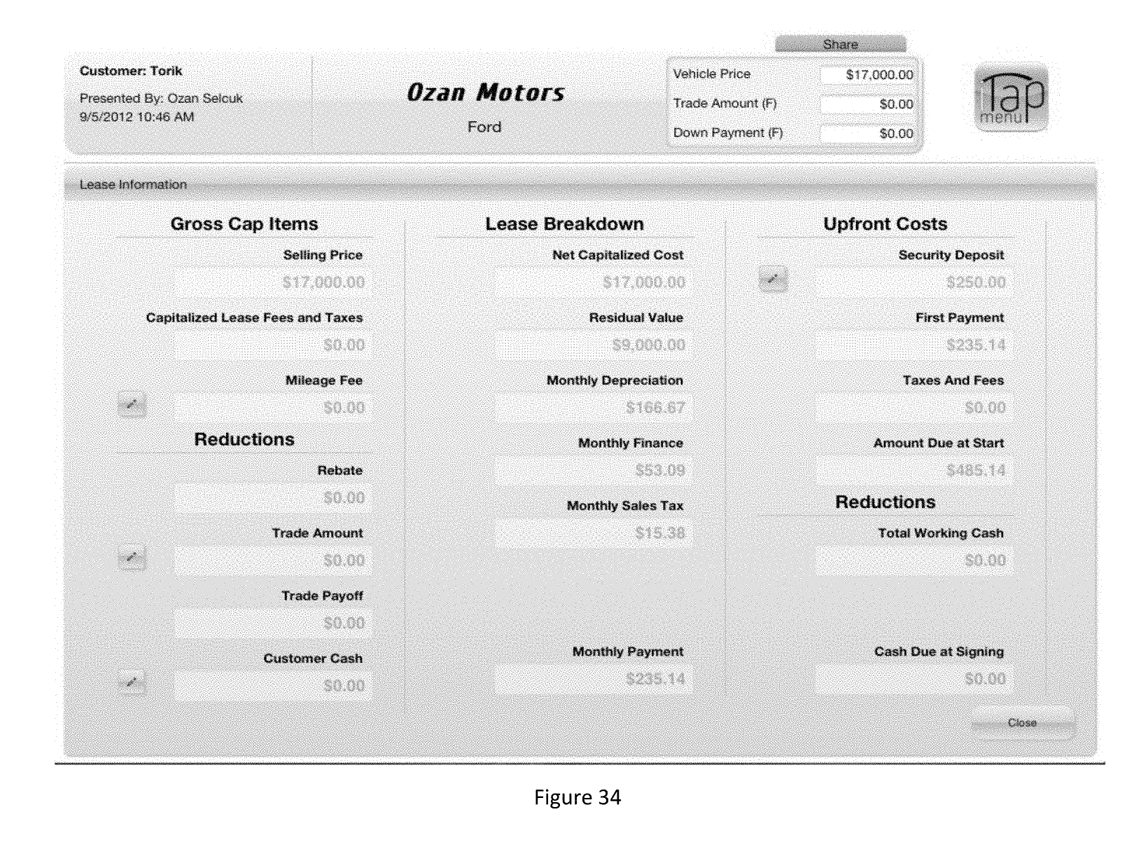

FIG. 34 shows the lease editor screen. The user can modify any of the fields with an edit button next to them. When the edit button is selected, a specific editor for that field will be displayed. When the user is finished, they close the editor at which time the changes will be reflected for the lease term option.

The editors allow a sales person to negotiate with the consumer by modifying the financial parameters of the purchase like interest rate, term, down payment, and price of the product. This, combined with the suppression of the selected options area, allows the sales person to focus on selling the products or package in the recommended area. If not, then the sales person and the consumer can build their own package in the selected options area.

FIGS. 28-34 show the suppression of the display of the selected options area. Once a user selects an F&I menu item for inclusion in the selected options area whose display has been suppressed, suppression of the display of the selected options area ceases. The selected options area is then displayed along with the selected F&I menu item icon, it being appreciated that an icon may be graphical, alphabetical or otherwise. Additional F&I menu items can then be placed into the selected options area as described above, such as with respect to FIGS. 1-5.

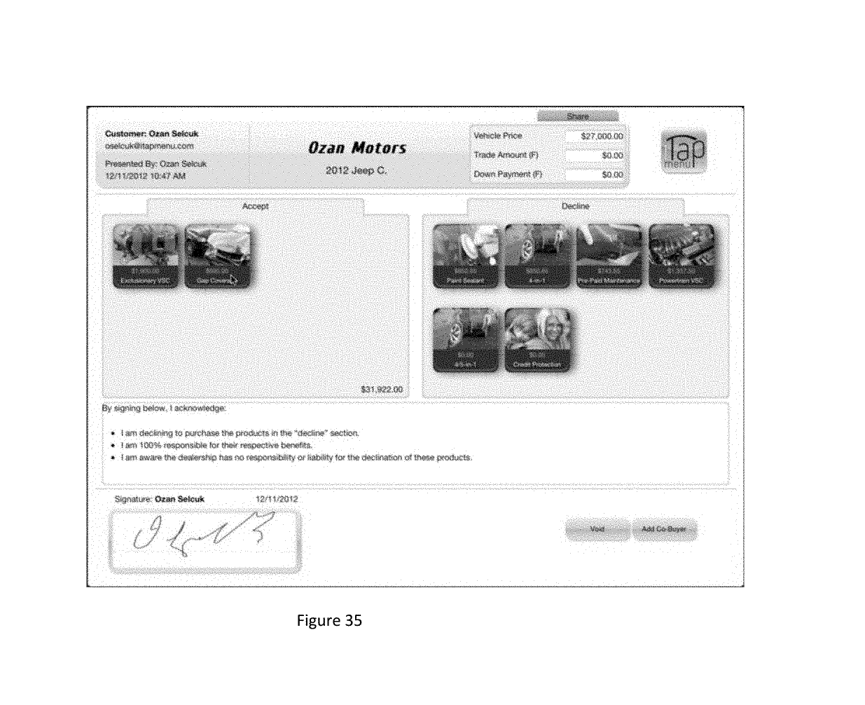

FIG. 35 shows the declination acknowledgment screen that is presented to the customer whenever the customer is purchasing the product but declining certain F&I menu items. The screen includes an “Accept” area showing the icons for those F&I menu items that the customer has decided to purchase and a “Decline” area showing the icons for those F&I menu items that the customer has decided not to purchase. The screen includes a place for the customer to enter his signature so as to expressly acknowledge that he is declining those F&I menu items shown in the “Decline” are of the screen. All of the relevant information for the deal, including an indication of the accepted and declined F&I menu items are stored in an F&I database that may be utilized in the “sell more” and “timeline” features described more fully below.

Code executed when editors are launched. When the page loads the number pad is configured to pop up when someone touches the text boxes in the upper right hand corner of the screen.

window.numberPad a new menu.presentation.views.NumberPad( );

numberPad.attach(‘.i-number-pad’);
<% if (!Model.Signed)
{ %>
numberPad.attach(‘.label-value.textfield’);

When the page loads, the term option button “wiggle events” is configured. After successfully activating it will display the editor for either finance or lease.

```
var termWiggles = new menu.presentation.views.WiggleItem({
                selector: ‘.real-terms .longdelay’,
                delay: 1500,
                Wiggled: function($this, e) {
                    var parent = $this.parent( )[0];
                    var lane = $this.closest(‘.lane’).parent( ).attr(‘class’);
                    $(‘.term.editor.dialog’).attr(‘current’, lane);
                    var width = parent.offsetWidth;
                    var top = 495;
                    var left = parent.offsetLeft;
                    var repo = page.repo.termsRepo;
                    var termItem = repo.all.where(‘Id’, ‘=’,
$this.attr(‘id’)).single( );
                    if (termItem && termItem.TermTypeId == 2) {
                        $(‘.term.editor.dialog #Term’).val(termItem.Term);
                        $(‘.term.editor.dialog
#Amortization’).val(termItem.AmortizationPeriod);
                        $(‘.term.editor.dialog
#Rate’).val(DisplayInterest(termItem.Interest).replace(‘ %’, ‘’));
                        $(‘.term.editor.dialog #sample’).text($this.text( ));
                        $(‘.term.editor.dialog’).attr(‘termId’, termItem.Id);
                        $(‘.term.editor.dialog’).css(‘width’, width).css(‘top’,
top).css(‘left’, left);
                        $(‘.term.editor.dialog
#PaymentFreq’).val(termItem.PaymentFrequencyId);
                        if (!termItem.AmortizationPeriod) {
                            $(‘.term.editor.dialog #Amortization’).hide( );
                            $(‘.term.editor.dialog #Amortization_Label’).hide( );
                            $(‘.term.editor.dialog #Term_Label’).css(‘width’, ‘50%’);
                            $(‘.term.editor.dialog #Term’).css(‘margin-left’, ‘45px’);
                        } else {
                            $(‘.term.editor.dialog #Amortization’).show( );
                            $(‘.term.editor.dialog #Amortization_Label’).show( );
                            $(‘.term.editor.dialog #Term_Label’).css(‘width’, ‘24%’);
                            $(‘.term.editor.dialog #Term’).css(‘margin-left’, ‘0px’);
                        }
                        setTimeout(function( ) { $(‘.term.editor.dialog’).show( ); },
100);
                    }
                    if (termItem && termItem.TermTypeId == 3) {
                        setTimeout(function( ) { ShowLeaseEditor(lane, termItem); },
100);
                    }
                },
                notWiggled: function ($Vthis, event) {
                    page.view.handlers.fireTermOptionSelected(event);
                }
            });
```

After the number pad closes, this code is used to update the fields and send the data to the server. After the server is updated, the lane calculator is called to update all of the term option buttons:

```
$(‘.label-value.textfield.amount1’).blur(function( ) {
    var type = page.model.displaySettings.CustomDisplayItem1Id;
    var value = parseFloat($(this).val( ));
    if (!isNaN(value)) {
        $(this).text(value.toCurrency( ));
        updateDisplayField(type, value);
    }
});
$(‘.label-value.textfield.amount2’).blur(function( ) {
    var type = page.model.displaySettings.CustomDisplayItem2Id;
    var value = parseFloat($this).val( ));
    if (!isNaN(value)) {
        $(this).text(value.toCurrency( ));
        updateDisplayField(type, value);
    }
});
$(‘.label-value.textfield.amount3’).blur(function( ) {
    var type = page.model.displaySettings.CustomDisplayItem3Id;
    var value = parseFloat($(this).val( ));
    if (!isNaN(value)) {
        $(this).text(value.toCurrency( ));
        updateDisplayField(type, value);
    }
});
var updateDisplayField = function(type, value) {
    var menuId = $(‘#menuId’).val( );
    var formData = ‘menuId=’ + menuId + ‘&type=’ + type +
‘&value=’ + value; $.ajax({
        url: page.urls.updateDisplayField,
        type: ‘POST’,
        data: formData,
        //dataType; ‘json’,
        beforeSend: function (/*xhr, settings*/) {
        },
        success: function (data /*, status, xhr*/) {
            if (data.Success) {
                switch (type) {
                case 1:
                    page.model.financeInfo.SalesPrice = value;
                    break;
                case 2:
            //page.model.financeInfo
                    break;
                case 3:
                    page.model.financeInfo.DownPayment = value;
                    break;
                case 4:
                    page.model.financeInfo.LeaseInfo.-
                    CustomerCash = value;
                    break;
                case 5:
                    page.model.financeInfo.TradeAmount = value;
                    break;
                case 6:
                    page.model.financeInfo.LeaseInfo.-
                    TradeAmount = value;
                    break;
                default:
                //
                }
                page.laneCalculator.update_all( );
            } else {
                alert(data.Error);
            }
        },
        error: function (/*xhr, status, error*/) {
            alert(“An error occurred while contacting the server”);
        },
        complete: function (/*xhr, status */) {
        }
    });
};
```

Code for the number pad that pops up:

```
views = namespace ‘menu.presentation.views’
delay = (ms, func) -> setTimeout func, ms
class _NumberPad extends views,View
      render: ->
            @overlay = @renderOverlay( )
            @el = @renderWindow( )
            @renderInputBox( )
            @renderNumbers( )
      renderOverlay: ->
            ($ ‘<div />’, { class: ‘number_edit_overlay’, style:
‘display: none;’ })[0]
      renderWindow: ->
            ($ ‘<div />’, { class: ‘number_edit_pad gradient’,
style: ‘display: none;’})[0]
      renderInputBox: ->
            wrap = ($ ‘<div />’)
            ($ ‘<span />’, { type: ‘text’, style: ‘float: left;’, class:
‘input_editor’}).appendTo wrap
            ($ ‘<ul />’),append($(‘<li />’, {text: ‘C’, class:
‘gradient orange’, style: ‘float:left;’})).appendTo wrap
            wrap.append ($ ‘<div />’, { class: ‘clear’ })
            wrap.appendTo @el
      renderNumbers: ->
            wrap = ($ ‘<ul />’, {style: ‘width: 300px;’ })
            @renderButton digit, wrap, ‘’ for digit in [9...0]
            @renderButton ‘Done’, wrap, ‘orange done’
            @renderButton ‘.’, wrap, ‘’
            @renderButton 0, wrap, ‘’
            wrap.append ($ ‘<div />’, { class: ‘clear’ })
            wrap.appendTo @el
            return
      renderButton: (digit, parent, moreClass) ->
            ($ ‘<li />’, {text: digit, class: “gradient
#{moreClass}”}).appendTo parent
            return
class NumberPad extends _NumberPad
      constructor: ->
            super
            $(‘body’).append @overlay
            $(‘body’).append @el
            @$(‘li:not(.orange.done)’).bind ‘touchstart’,
            (e) => @pressed e
            @$(‘li.done’).bind ‘click’, (e) => @finished e
            @value = ‘’
      attach: (selector) ->
            $(selector).prop(‘readonly’, true).bind ‘click’,
      (e) => @show e pressed: (event) ->
            newValue = $(event.target).text( )
            if newValue is ‘C’
                  @clear( )
            else
                  @value += newValue
                  delay 100, => @$(‘.input_editor’).text @value
            return
      clear: ->
            @value = ‘’
            @$(‘.input_editor’).text(‘’)
      finished: ->
            if (@$(‘.input_editor’).text( ) isnt ‘’)
                  @field.val(@$(‘.input_editor’).text( ))
            @field.blur( )
            @clear( )
            $(@overlay).hide( )
            delay 200, => $(@el).hide( )
            return
      show: (event) ->
            @field = $(event.target)
            $(@overlay).show( )
            $(@el).show( )
views.NumberPad = NumberPad;
```

Code for the Lane Calculator:

```
views = namespace ‘menu.presentation.views’
clone = (obj) ->
  if not obj? or typeof obj isnt ‘object’
    return obj
  newInstance = new obj.constructor( )
  for key of obj
    newInstance[key] = clone obj[key]
  return newInstance
class Lane
      constructor: (parent, name, terms) ->
            @parent = parent
            @lowerName = name
            @name = @upperCaseFirstChar name
            @terms = (clone term for term in terms)
            @financeInfo = page.model.financeInfo
            @productRepo = page.repo.productRepo
            @formatter = menu.presentation.domain.model.TermOptionFormatter
            @discountLabel = $(‘.discount.label’, @parent)
      draw: ->
            products = @products( )
            @updateDisplay term, @monthlyPaymentFor(products, term) for term in
@terms
            @updateDiscountLabel( );
            return
      updateDiscountLabel: ->
            @discountLabel.css ‘visibility’, ‘visible’ if
(page.model.columnDiscounts[@lowerName] ? 0) > 0
            @discountLabel.css ‘visibility’, ‘hidden’ if
(page.model.columnDiscounts[@lowerName] ? 0) is 0
            discount = $.global.format @discount( ), ‘p’
            amount = $.global.format @discountAmount( ), ‘c’
            @discountLabel.text “#{discount} discount (#{amount} savings)”
      monthlyPaymentFor: (products, term) ->
            lastPayment = 0
            idx = 0
            @resetCreditInsuranceProduct product for product in products when
product.EditorTypeId is 2
            while idx < 6 or lastPayment is not payment
                  lastPayment = payment
                  payment = @_monthlyPaymentFor products, term
                  idx++
            payment
      _monthlyPaymentFor: (products, term) ->
            monthlyTerm = clone term
            monthlyTerm.PaymentFrequencyId = 1
            payment = @financeInfo.MonthlyPaymentFor products, monthlyTerm,
@discount( )
            balloon = (t) => @financeInfo.BalloonPaymentFor products, t, @discount( )
            @calculatePaymentWithCreditInsurance payment, term, balloon
            @financeInfo.MonthlyPaymentFor products, term, @discount( )
      resetCreditInsuranceProduct: (product) ->
            product.RetailPrice = 0
            product.YourPrice = 0
            return
      calculatePaymentWithCreditInsurance: (payment, term, balloon) ->
            group = (@products( ). filter (product) -> product.IsGroup)[0]
            if group && term.TermTypeId isnt 1
                  settings = new views.CreditInsuranceSettings( )
                  settings.createLane @lowerName unless settings.exists @lowerName
                  products = settings.productsFor @lowerName
                  laneGroup = settings.groupFor @lowerName
                  @updateProductPrice payment, product, term, balloon for product
in products
                  group.RetailPrice = 0
                  group.RetailPrice += product.RetailPrice for product in products
                  group.YourPrice = group.RetailPrice
                  laneGroup.RetailPrice = group.RetailPrice
                  laneGroup.YourPrice = group.YourPrice
      updateProductPrice: (base, product, term, balloon) ->
            product.RetailPrice = 0
            product.YourPrice = 0
            if product.CreditInsuranceInformation.IsAvailable
                  ci = product.CreditInsuranceInformation
                  interpolator = new views.CreditInsuranceInterpolator
page.model.factors
                  termForCalc = clone term
                  termForCalc.Term = Math.min (ci.Term ? term.Term), term.Term
                  termForCalc.AmortizationPeriod = term.Term unless
term.AmortizationPeriod
                  termForCalc.PaymentFrequencyId = 1
                  #console.log ‘term ->’, termForCalc
                  factor = interpolator.getFactor product.TPAProductId,
ci.SubCodeId, termForCalc.Term
                  if factor
                        coverage = if parseInt(ci.CoverageId) is 2 then 1.8 else 1
                        if term.TermTypeId is 3
                              tax = 0
                              product.RetailPrice = base * (termForCalc.Term −
1) * (factor / 100) * coverage
                              if ci.CoverResidual
                                    level = interpolator.getLevelFactor
product.TPAProductId, ci.SubCodeId, termForCalc.Term
                                    if level
                                          console.log ‘level’, term
                                          console.log term.Residual * (level /
100)
                                          product.RetailPrice += term.Residual
* (level / 100)
                              if product.TaxOverride
                                    tax = product.RetailPrice *
product.TaxOverride
                                    product.RetailPrice += tax
                              #console.log “(#{base} * #{termForCalc.Term-1} *
(#{factor} / 100) * #{coverage}) = #{product.RetailPrice}”
                        else
                              product.RetailPrice = base * termForCalc.Term *
(factor / 100) * coverage
                              if termForCalc.AmortizationPeriod
                                    level = interpolator.getLevelFactor
product.TPAProductId, ci.SubCodeId, termForCalc.Term
                                    if level
                                          balloonPayment = balloon termForCalc
                                          #console.log “#{product.RetailPrice}
+ (#{balloonPayment} * (#{level} / 100)”
                                          additional = balloonPayment * (level
/ 100)
                                          #console.log “#{product.RetailPrice}
+ #{additional} = “ + (product.RetailPrice + additional)
                                          product.RetailPrice += additional if
additional > 0
                        product.YourPrice = product.RetailPrice
                        product.Cost = product.RetailPrice
      updateDisplay: (term, payment) ->
            $(“li[id=#{term.Id}]”, @parent).text(@formatter.formatFor(term,
payment))
      discount: ->
            page.model.columnDiscounts[@lowerName] ? 0
      discountAmount: ->
            amount = 0
            amount += product.YourPrice for product in @products( )
            amount * @discount( )
      products: ->
            @productRepo.all.where(@name, ‘=’, true).and(‘Available’, ‘=’,
true).list( )
      upperCasefirstChar: (word) ->
            word.charAt(0).toUpperCase( ) + word.slice 1
      replaceTerm: (newTerm) ->
            @clone newTerm, term for term in @terms when term.Id is newTerm.Id
            return
      clone: (src, dest) ->
            dest[prop] = src[prop] for prop of src
            return
class LaneCalculator
      bind_all: ->
            parents = $(‘ul.termOptions’).closest(‘.lane’).parent( ).toArray( )
            @lanes = (new Lane parent, parent.className, page.model.terms[0...] for
parent in parents)
            @
      update_all: ->
            lane.draw( ) for lane in @lanes
            @
      update_term: (newTerm, laneName) ->
            lane.replaceTerm newTerm for lane in @lanes if laneName is undefined
            lane.replaceTerm newTerm for lane in @lanes when lane.name is
lane.upperCaseFirstChar laneName if laneName isnt undefined
            @
      termFor: (lane, termId) ->
            lane = @laneFor lane
            (lane.terms.filter (t) -> t.Id is termId)[0]
      laneFor: (laneName) ->
            (lane for lane in @lanes when lane.name is lane.upperCaseFirstChar
laneName if laneName isnt undefined)[0]
views.LaneCalculator = LaneCalculator
```

Code for the Wiggle Item object:

```
views = namespace ‘menu.presentation.views’
delay = (ms, func) -> setTimeout func, ms
views.WiggleItem =
class WiggleItem
      scaleX: 1.2
      scaleY: 1.2
      constructor: (options) ->
            @selector = options.selector
            @delay = options.delay
            @shouldWiggle = options.shouldWiggle ? -> true
            @wiggled = options.wiggled ? ->
            @notwiggled = options.notWiggled ? ->
            @scaleX = options.scaleX ? @scaleX
            @scaleY = options.scaleY ? @scaleY
            @supportsTouch = ‘’ontouchstart’ in document.documentElement’
            @bind( )
      bind: ->
            @bindTouch( ) if @supportsTouch
            @bindMouse( ) unless @supportsTouch
            $(@selector).live ‘selectstart’, -> false
            @
      bindTouch: ->
            $(@selector).live ‘touchstart’, (e) => @wiggle(e)
            $(@selector).live ‘touchend’, (e) => @completeWiggle(e)
            @
      bindMouse: ->
            $(@selector).live ‘mousedown’, (e) => @wiggle(e)
            $@selector).live ‘mouseup’, (e) => @completeWiggle(e)
            @
      wiggle: (event) =>
            if @shouldWiggle( )
                  console.log ‘started wiggle’
                  started = new Date( )
                  scaleX = @scaleX
                  scaleY = @scaleY
                  $this = $ event.currentTarget
                  $this.data ‘longdelay’, started.getTime( )
                  delay 1000, -> $this.css ‘-webkit-transform’, “scale3d(#{scaleX},
#{scaleY}, 1)” if $this.data ‘longdelay’
                  delay @delay, -> $this.addClass ‘wiggle’ if $this.data
‘longdelay’
            else console.log “shouldn't wiggle”
            @
      completewiggle: (event) =>
            if @shouldWiggle( )
                  console.log ‘completed wiggle’
                  $this = $ event.currentTarget
                  $this.css ‘-webkit-transform’, ‘’
                  $this.removeClass ‘wiggle’
                  if (@elapsed $this) < @delay
                        @notWiggled $this, event
            else
                  @wiggled @this, event
      @
elapsed: ($this) ->
      started = $this.data ‘longdelay’
      $this.removeData ‘longdelay’
      end = new Date( )
      end.getTime( ) − started
```

Code for the Finance Term Editor:

```
$(‘.term.editor.dialog #Amortization’).blur(function( ) {
  updateTermEditorSample( );
});
$(‘.term.editor.dialog #Rate’).blur(function( ) {
  updateTermEditorSample( );
});
$(‘.term.editor.dialog #Term’).blur(function( ){
  updateTermEditorSample( );
});
$(‘.term.editor.dialog #PaymentFreq’).change(function( ) {
  updateTermEditorSample( );
});
var updateTermEditorSample = function( ) {
  var term = undefined;
  var repo = page.repo.productRepo;
  var termRepo = page.repo.termsRepo;
  var current = $(‘.term.editor.dialog’).attr(‘current’);
  var months = parseInt($(‘.term.editor.dialog #Term’).val( ));
  var amort = parseInt($(‘.term.editor.dialog #Amortization’).val( ));
  var rate = parseFloat($(‘.term.editor.dialog #Rate’).val( ));
  var freq = parseInt($(‘.term.editor.dialog #PaymentFreq option:selected’).val( ));
  var interest = rate / 100;
  var termId = $(‘.term.editor.dialog’).attr(‘termId’);
  var termItem = termRepo.all.where(‘Id’, ‘=’, termId).single( );
  if (termItem && termItem.TermTypeId == 2){
    term = $.extend({ }, termItem);
    term.Term = months;
    term.Interest = interest;
    term.PaymentFrequencyId = freq;
    if (isNaN(amort)) {
      term.AmortizationPeriod = null;
    } else {
      term.AmortizationPeriod = amort;
    }
  }
  var products = [ ];
  if (current === ‘custom’){
    products = repo.all.where(‘Custom’, ‘=’, true).and(‘Available’, ‘=’,
true).list( );
  }
  if (current === ‘recommended’){
    products = repo.all.where(‘Recommended’, ‘=’, true).and(‘Available’, ‘=’,
true).list( );
  }
  if (current === ‘preferred’){
    products = repo.all.where(‘Preferred’, ‘=’, true).and(‘Available’, ‘=’,
true).list( );
  }
  if (current === ‘limited’){
    products = repo.all.where(‘Limited’, ‘=’, true).and(‘Available’, ‘=’,
true).list( );
  }
  if (current === ‘basic’){
  products = repo.all.where(‘Basic’, ‘=’, true).and(‘Available’, ‘=’,
true).list( );
  }
  var monthlyPaymentFor = page.model.financeInfo.MonthlyPaymentFor(products, term);
  var label = menu.presentation.domain.model.TermOptionFormatter.formatFor(term,
monthlyPaymentFor);
  $(‘.term.editor.dialog #sample’).text(label);
};
$(‘.term.editor.dialog .save.button’).click(function( ){
  var term = undefined;
  var repo = page.repo.productRepo;
  var termRepo = page.repo.termsRepo;
  var months = parseInt($(‘.term.editor.dialog #Term’).val( ));
  var rate = parseFloat($(‘.term.editor.dialog #Rate’),val( ));
  var amort = parseInt($(‘.term.editor.dialog #Amortization’).val( ));
  var freq = parseInt($(‘.term.editor.dialog #Paymentfreq option:selected’).val( ));
  var applyToAll = $(‘.term.editor.dialog #TermEditApplyToAll’).is(‘:checked’);
  var interest = rate / 100;
  var termId = $(‘.term.editor.dialog’).attr(‘termId’);
  var termItem = termRepo.all.where(‘Id’, ‘=’, termId).single( );
  var lane = $(‘.term.editor.dialog’).attr(‘current’);
  if (termItem && termItem.TermTypeId == 2){
    term = termItem;
    term.Term = months;
    term.Interest = interest;
    term.AmortizationPeriod = amort;
    term.PaymentFrequencyId = freq;
    if (applyToAll)
      page.laneCalculator.update_term(term);
    else
      page.laneCalculator.update_term(term, lane);
    termRepo.save(term);
  }
  page.laneCalculator.update_all( );
  $(‘.term.editor.dialog’).hide( );
});
$(‘.term.editor.dialog .cancel.button’).click(fonction( ){
  $(‘.term.editor.dialog’).hide( );
});
```

Code for the Lease Term Editor:

```
$(‘.lease.editor.dialog #LeaseFeesEditButton’).click(function( ){
  var feeEditor = $(‘.leasefee.editor.dialog’);
  $.each(page.model.financeInfo.LeaseInfo.LeasingFees, function(index, value){
    $(‘.feelist’, feeEditer).append($‘<li />’, {id ; value.Id }).html(‘<a href=“”
class=“fee-remove” style=“margin-right: 15px;” >remove</a> ’ + value.Name + ‘ ’ +
value.Amount.toCurrency( )));
  });
  feeEditor.data(‘fees’, page.model.financeInfo.LeaseInfo.LeasingFees.slice(0));
  var removeFee = function(id){
    $(‘#remove-’ + id, ‘#accept-form’).remove( );
    $.each(pege.model.financeInfo.LeaseInfo.LeasingFees, function(index, value){
      if (!value) return;
      if (value.id === id){
        page.model.financeInfo.LeaseInfo.LeasingFees.splice(index, 1);
      }
    });
  };
  $(‘.fee-remove’, feeEditor).live(‘click’, function(e){
    e.preventDefault( );
    var id = $(this).parent( ).attr(‘id’);
    $(this).parent( ).remove( );
    removeFee(id);
  });
  $(‘.add.button’, feeEditor).click(function(e) {
    e.preventDefault( );
    var name = $(‘.fees.name’, feeEditor).val( );
    var amount = parseFloat($‘.fee.amount’, feeEditor).val( ) || 0);
    var menuId = $(‘#MenuId’, feeEditor).val( );
    var feeId = page.model.feeIds.pop( );
    var feeElement = $(‘<li />’, {id : feeId }).html(‘<a href=“” class=“fee-remove”
style=“margin-right: 15px;” >remove</a> ’ + name + ‘ ’ + amount.toCurrency( ));
    $(‘.feelist’, feeEditor).append(feeElement);
    $(‘.fee.name’, feeEditor).val(‘’);
    $(‘.fee.amount’, feeEditor).val(‘’);
    var fee = {
      Id: feeId,
      MenuId: menuId,
      Name: name,
      Amount: amount
    };
    page.model.financeInfo.LeaseInfo.LeasingFees.push(fee);
    $(‘#accept-form’).append(tmpl(‘leaseFee_tmpl’, fee));
  });
  $(‘.save.button’, feeEditor).click(function(e){
    e.preventDefault( );
    $(‘.feelist’, feeEditor).children( ).remove( );
    $(‘.save.button’, feeEditor).unbind( );
    $(‘.cancel.button’, feeEditor).unbind( );
    $(‘.add.button’, feeEditor).unbind( );
    UpdateLeaseEditor( );
    feeEditor.hide( );
  });
  $(‘.cancel.button’, feeEditor).click(function(e){
    e.preventDefault( );
    $(‘.feelist’, feeEditor).children( ).remove( );
    $(‘.save.button’, feeEditor),unbind( );
    $(‘.cancel.button’, feeEditor).unbind( );
    $(‘.add.button’, feeEditor).unbind( );
    $(‘.remove.lease.fee’, $(‘#accept-form’)).remove( );
    page.model.financeInfo.LeaseInfo.LeasingFees = feeEditor.data(‘fees’);
    $.each(page.model.financeInfo.LeaseInfo.LeasingFees, function(index, value){
      $(‘#accept-form’).append(tmpl(‘leaseFee_tmpl’, value));
    });
    UpdateLeaseEditor( );
    feeEditor.hide( );
  });
  feeEditor.show( );
});
$(‘.lease.editor.dialog #CustomerCashEditButton’).click(function( ) {
  var field = ‘#LeaseInformation_CashIsUpfront’;
  var reduction_field = ‘#LeaseInformation_CustomerCash’;
  var $dialog = $(‘.leasereduction.editor.dialog’);
  var $accept = $(‘#accept-form’);
  $(‘#Reduction’, $dialog).val((page.medel.financeInfo.LeaseInfo.CustomerCash ||
0).toCurrency( ));
  $(‘.reduction.label’, $dialog).text(‘Customer Cash’);
  $(‘.save.button’, $dialog).click(function( ){
    var upfront = $(‘#upfront’, $dialog).is(‘:checked’);
    var reduction = parseFloat($(‘#Redection’,
$dialog).val( ).replace(‘$’, ‘’).replace(‘,’, ‘’));
    $(field, $accept).val(upfront);
    $(reduction_field, $accept).val(reduction);
    page.model.financeInfo.LeaseInfo.CashIsUpfront = upfront;
    page.model.financeInfo.LeaseInfo.CustomerCash = reduction;
    UpdateLeaseEditor( );
    $(‘.save.button’).unbind( );
    $(‘.cancel.button’).unbihd( );
    $dialog.hide( );
  });
  $(‘.cancel.button’, $dialog).click function( ){
    $(‘.save.button’).unbind( );
    $(‘.cancel.button’).unbind( );
    $dialog.hide( );
  });
  var isUpfront = $(field, $accept).var( ) === ‘True’ || $(field, $accept).val( ) ===
‘true’;
  if (isUpfront){
    $(‘.cb-disable’, $dialog).removeClass(‘selected’);
    $(‘.cb-enable’, $dialog).addClass(‘selected’);
    $(‘.checkbox’,$dialog).prop(‘checked’, true);
  } else {
    $(‘.cb-disable’, $dialog).addClass(‘selected’);
    $(‘.cb-enable’, $dialog).removeClass(‘selected’);
    $(‘.checkbox’,$dialog).prop(‘checked’, false);
  }
  $dialog.show( );
});
$(‘.lease.editor.dialog #RebateEditButton’).click(function( ) {
  var field = ‘#LeaseInformation_RebateIsUpfront’;
  var reduction_field = ‘#LeaseInformation_Rebate’;
  var $dialog = $(‘.laeasereduction.editor.dialog’);
  var $accept = $(‘#accept-form’);
  $(‘#Reduction’, $dialog).val((page.model.financeInfo.LeaseInfo.Rebate ||
0).toCurrency( ));
  $(‘.reduction.label’, $dialog).text(‘Rebate’);
  $(‘.save.button’, $dialog).click(function( ){
    var upfront = $(‘#upfront’, $dialog).is(‘:checked’);
    var reduction = parseFloat($(‘#Reduction’,
$dialog).val( ).replace(‘$’,‘’).replace(‘,’, ‘’));
    $(field, $accept).val(upfront);
    $(reduction_field, $accept).val(reduction);
    page.model.financeInfo.LeaseInfo.RebateIsUpfront = upfront;
    page.model.financeInfo.LeaseInfo.Rebate = reduction;
    UpdateLeaseEditor( );
    $(‘.save.button’).unbind( );
    $(‘.cancel.button’).unbind( );
    $dialog.hide( );
  });
  $(‘.cancel.button’, $dialog).click(function( ){
    $(‘.save.button’).unbind( );
    $(‘.cancel.button’).unbind( );
    $dialog.hide( );
  });
  var isUpfront = $(field, $accept).val( ) === ‘True’ || $(field, $accept).val( ) ===
‘true’;
  if (isUpfront){
    $(‘.cb-disable’, $dialog).removeClass(‘selected’);
    $(‘.cb-enable’, $dialog).addClass(‘selected’);
    $(‘.checkbox’,$dialog).prop(‘checked’, true);
  } else {
    $(‘.cb-disable’, $dialog).addClass(‘selected’);
    $(‘.cb-enable’, $dialog).removeClass(‘selected’);
    $(‘.checkbox’,$dialog).prop(‘checked’, false);
  }
  $dialog.show( );
});
$(‘.lease.editor.dialog #TradeAmountEditButton’).click(function( ) {
  var field = ‘#LeaseInformation_TradeIsUpfront’;
  var reduction_field = ‘#LeaseInformation_TradeAmount’;
  var $dlialog = $(‘.leasereduction.editor.dialog’);
  var $accept = $(‘#accept-form’);
  $(‘#Reduction’, $dialog).val((page.model.financeInfo.LeaseInfo.TradeAmount ||
0).toCurrency( ));
  $(‘.reduction.label’, $dialog).text(‘Trade Amount’);
  $(‘.sava.button’, $dialog).click(function( ){
    var upfront = $(‘#upfront’, $dialog).is(‘:checked’);
    var reduction = parseFloat($(‘#Redection’,
$dialog).val( ).replace(‘$’,‘’).replace(‘,’,‘’));
    $(field, $accept).val(upfront);
    $(reduction_field, $accept).val(reduction);
    page.model.financeInfo.LeaseInfo.TradeIsUpfront = upfront;
    page.model.financeInfo.LeaseInfo.TradeAmount = reduction;
    UpdateLeaseEditor( );
    $(‘.save.button’).unbind( );
    $(‘.cancel.button’).unbind( );
    $dialog.hide( );
  });
  $(‘.cancel.button’, $dialog).click(function( ){
    $(‘.save.button’).unbind( );
    $(‘.cancel.button’).unbind( );
    $dialog.hide( );
  });
  var isUpfront = $(field, $accept).val( ) === ‘True’ || $(field, $accept).val( ) ===
‘true’;
  if (isUPfront){
    $(‘.cb-disable’, $dialog).removeClass(‘selecte’);
    $(‘.cb-enable’, $dialog).addClass(‘selected’);
    $(‘.checkbox’,$dialog).prop(‘checked’, true);
  } else {
    $(‘.cb-disable’, $dialog).addClass(‘selected’);
    $(‘.cb-enable’, $dialog).removeClass(‘selected’);
    $(‘.checkbox’,$dialog).prop(‘checked’, false);
  }
  $dialog.show( );
});
$(‘.lease.editor.dialog #OverageFeesEditButton’).click(function( ) {
  var $dialog = $(‘.leasemiles.editor.dialog’);
  var $accept = $(‘#accept-form’);
  $(‘.cancel.button’, $dialog).click(function( ){
    $(‘#MileageAllowed’, $dialog).val($(‘#LeaseInformation_MileageAllowed’,
$accept).val( ));
    $(‘#MileageExpected’, $dialog).val($(‘#LeaseInformation_MileageExpected’,
$accept).val( ));
    $(‘#MileageCost’, $dialog).val(parseFloat($(‘#LeaseInformation_MileageCost’,
$accept).val( )).toCurrency( ));
    $(‘.save.button’, $dialog).unbind( );
    $(‘.cancel.button’, $dialog).unbind( );
    UpdateLeaseEditor( );
    $dialog.hide( );
  });
  $(‘.save.button’, $dialog).click(function( ){
    var allowed = parseInt($(‘#MileageAllowed’, $dialog).val( ));
    var expected = parseInt($(‘#MileageExpected’, $dialog).val( ));
    var cost = parseFloat($(‘#MileageCost’, $dialog).val( ).replace(‘$’, ‘’));
    $(‘#LeaseInformation_MileageAllowed’, $accept).val(allowed);
    $(‘#LeaseInformation_MileageExpected’, $accept).val(expected);
    $(‘#LeaseInformation_MileageCost’, $accept).val(cost);
    $(‘.save.button’, $dialog).unbind( );
    $(‘.cancel.button’, $dialog).unbind( );
    page.model.financeInfo.LeaseInfo.MileageAllowed = allowed;
    page.model.financeInfo.LeaseInfo.MileageExpected = expected;
    page.model.financeInfo.LeaseInfo.MileageCost = cost;
    UpdateLeaseEditor( );
    $dialog.hide( );
  });
  $dialog.show( );
});
$(‘.lease.editor.dialog #SecurityDepositEditButton’).click(function( ){
  var $dialog = $(‘.leasedeposit.editor.dialog’);
  var $accept = $(‘#accept-form’);
  $(‘#SecurityDeposit_Select’, $dialog).change(function( ){
    $(‘#SecurityDeposit_Select option:selected’).each(function( ){
      var selected = $(this).val( );
      if (selected == 1){
        $(‘#LeaseInformation_SecurityDeposit’, $dialog).val(0);
        $(‘.dep-wrap’).hide( );
      }
      if (selected == 2){
        $(‘#LeaseInformation_SecurityDeposit’, $dialog).val(‘’);
        $(‘.dep-wrap’).hide( );
      }
      if (selected == 3){
        $(‘#LeaseInformation_securityDeposit’, $dialog).val(0);
        $(‘.dep-wrap’).show( );
      }
    });
  });
  $(‘.cancel.button’, $dialog).click(function( ){
    $(‘.cancel.button’, $dialog).unbind( );
    $(‘.save.button’, $dialog).unbind( );
    $(‘#SecurityDeposit_Select’, $dialog).unbind( );
    UpdateLeaseEditor( );
    $dialog.hide( );
  });
  $(‘.save.button’, $dialog).click(function( ){
    $(‘.cancel.button’, $dialog).unbind( );
    $(‘.save.button’, $dialog).unbind( );
    $(‘#SecurityDeposit_Select’, $dialog).unbind( );
    var deposit = $(‘#LeaseInformation_SecurityDeposit’, $dialog).val( );
    if (deposit !== ‘’){
      deposit = parseFloat(deposit);
    }
    $(‘#LeaseInformation_SecurityDeposit’, $accept).val(deposit);
    page.model.financeInfo.LeaseInfo.SecurityDeposit = deposit;
    UpdateLeaseEditor( );
    $dialog.hide( );
  });
  $dialog.show( );
});
$(‘.lease.editor.dialog #TaxAndFeesEditButton’).click(function( ){
  var $dialog = $(‘.leasetax.editor.dialog’);
  var $accept = $(‘#accept-form’);
  $(‘.cancel.button’, $dialog).click(function( ){
    $(‘.save.button’, $dialog).unbind( );
    $(‘.cancel.button’, $dialog).unbind( );
    UpdateLeaseEditor( );
    $dialog.hide( );
  });
  $(‘.save.button’; $dialog).click(function( ){
    $(‘.save.button’, $dialog).unbind( );
    $(‘.cancel.button’, $dialog).unbind( );
    var taxed = $(‘#LeaseInformation_CapCashIsTaxable’, $dialog).is(‘:checked’);
    $(‘#LeaseInformation_CapCashIsTaxable’, $accept).val(taxed);
    page.model.financeInfo.LeaseInfo.CapCashIsTaxable = taxed;
    taxed = $(‘#LeaseInformation_CapRebateIsTaxable’, $dialog).is(‘:checked’);
    $(‘#LeaseInformation_CapRebateIsTaxable’, $accept).val(taxed);
    page.model.financeInfo.LeaseInfo.CapRebateIsTaxable = taxed;
    taxed = $(‘#LeasaInformation_CapTradeIsTaxable’, $dialog).is(‘:checked’);
    $(‘#LeaseInformation_CapTradeIsTaxable’, $accept).val(taxed);
    page.model.financeInfo.LeaseInfo.CapTradeIsTaxable = taxed;
    taxed = $(‘#LeaseInformation_UpFrontCashIsTaxable’, $dialog).is(‘:checked’);
    $(‘#LeaseInformation_UpFrontCashIsTaxable’, $accept).val(taxed);
    page.,model.financeInfo.LeaseInfo.UpFrontCashIsTaxable = taxed;
    taxed = $(‘#LeaseInformation_UpFrontRebateIsTaxable’, $dialog).is(‘:checked’);
    $(‘#LeaseInformation_UpFrontRebateIsTexable’, $accept).val(taxed);
    page.model.financeInfo.LeaseInfo.UpFrontRebateIsTaxable = taxed;
    taxed = $(‘#LeaseInformation_UpFrontTradeIsTaxable’, $dialog).is(‘:checked’);
    $(‘#LeaseInformation_UpFrontTradeIsTaxable’, $accept).val(taxed);
    page.model.financeInfo.LeaseInfo.UpFrontTradeIsTaxable = taxed;
    UpdateLeaseEditor( );
    $dialog.hide( );
  });
  $dialog.show( );
});
function ShowLeaseEditor(lane, term){
  ver lease = page.model.financeInfo;
  lease.tmpProducts = lease.Products;
  lease.tmpResidual = lease.Residual;
  lease.tmpTerm = lease.LoanTerm;
  lease.tmpMoneyFactor = lease.MoneyFactor;
  lease.Products = [ ];
  lease.Residual = term.Residual || 0;
  lease.LoanTerm = term.Term;
  lease.Moneyfactor = term.MoneyFactor;
  lease.ResidualPercentage = term.ResidualPercentage || 0;
  UpdateLeaseEditor( );
  var $dialog = $(‘.lease.editor.dialog’);
  $(‘.close.button’, $dialog).click(function( ) {
    page.laneCalculator.update_all( );
    $dialog.hide( );
  });
  $dialog.show( );
}
function UpdateLeaseEditor( ){
  var lease = page.model.financeInfo;
  lease.FixLease( );
  var $dialog = $(‘.lease.editor.dialog’);
  var capFees = lease.GrossCapFees || 0;
  capFees += lease.TaxMethod == 1 ? lease.LeaseTaxableAmount : 0;
  var overageFees = lease.OverageFees || 0;
  var rebate = (lease.LeaseInfo.UpfrontRebate || 0) + (lease.LeaseInfo.CapRebate ||
0);
  var tradeAmount = lease.LeaseInfo.TradeAmount || 0;
  var tradePayoff = lease.LeaseInfo.TradePayoff || 0;
  var customerCash = lease.LeaseInfo.CustomerCash || 0;
  var netCapCost = lease.NetCapCost || 0;
  var residualValue = lease.ResidualValue || 0;
  var depreciation = lease.MonthlyDepreciation || 0;
  var finance = lease.MonthlyFinanceFee || 0;
  var salesTax = lease.MonthlySalesTax || 0;
  var payment = lease.MonthlyPayment || 0;
  var deposit = lease.SecurityDeposit || 0;
  var taxAndFee = lease.UpfrontTaxesAndFees || 0;
  var dueAtStart = lease.AmountDueAtStart || 0;
  var workingCash = lease.TotalWorkingCash || 0;
  var dueAtSigning = lease.AmountDueAtSigning || 0;
  $(‘#LeaseFees’, $dialog).val(capFees.toCurrency( ));
  $(‘#OverageFees’, $dialog).val(overageFees.toCurrency( ));
  $(‘#Rebate’, $dialog).val(rebate.toCurrency( ));
  $(‘#TradeAmount’, $dialog).val(tradeAmount.toCurrency( ));
  $(‘#TradePayoff’, $dialog).val(tradePayoff.toCurrency( ));
  $(‘#CustomerCash’, $dialog).val(customerCash.toCurrency( ));
  $(‘#NetCapCost’, $dialog).val(netCapCost.toCurrency( ));
  $(‘#ResidualValue’, $dialog).val(residualValue.toCurrency( ));
  $(‘#MonthlyDepreciation’, $dialog).val(depreciation.toCurrency( ));
  $(‘#MonthlyFinance’, $dialog).val(finance.toCurrency( ));
  $(‘#MonthlySalesTax’, $dialog).val(salesTax.toCurrency( ));
  $(‘#LeasePayment’, $dialog).val(payment.toCurrency( ));
  $(‘#SecurityDeposit’, $dialog).val(deposit.toCurrency( ));
  $(‘#FirstPayment’, $dialog).val(payment.toCurrency( ));
  $(‘#TaxAndFees’, $dialog).val(taxAndFee.toCurrency( ));
  $(‘#AmountDueAtStart’, $dialog).val(dueAtStart.toCurrency( ));
  $(‘#TotalWorkingCash’, $dialog).val(workingCash.toCurrency( ));
  $(‘#DueAtSigning’, $dialog).val(dueAtSigning.toCurrency( ));
};
```

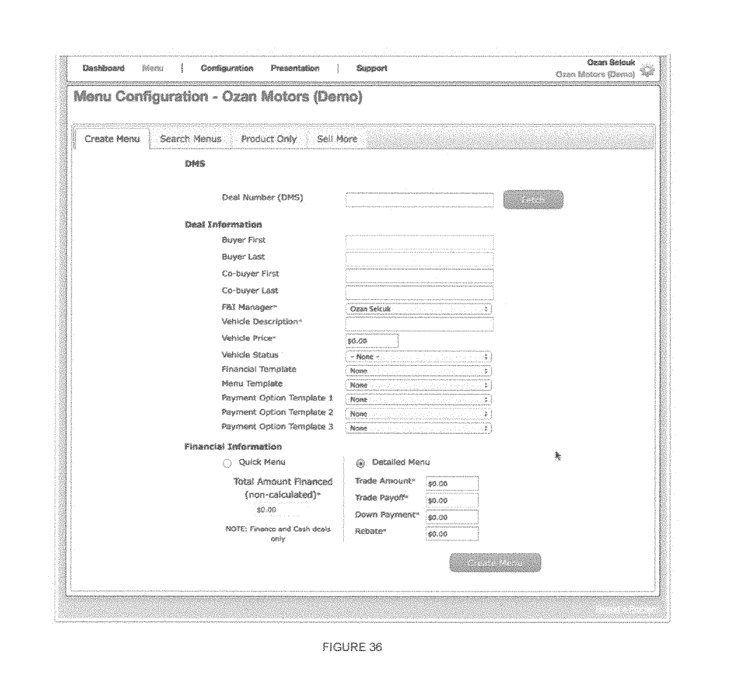

In addition, the system may be integrated to a dealer management system or DMS. Often, data for a particular “deal” such a customer name, vehicle type and price, etc., are entered into a DMS. By having the present system integrated, the data for a particular deal may be selected, which can avoid the need for duplicate data entry. FIG. 36 shows a menu creating screen of a back-end system. This screen is accessed by the salespersons/F&I manager by clicking the “create menu” tab shown at the top of the screen. The screen provides fields for the salesperson user to manually enter customer information for a proposed deal or to have customer information pulled from a DMS by entering the appropriate deal number in the text box and hitting the “fetch” button.

Another aspect provides a system and method for the generation of customized electronic messages to selected vehicle purchasers. These messages are sent to purchasers who previously declined certain F&I menu items and serve to generate additional sales opportunities for those F&I menu items that are amenable to a post sale purchase.

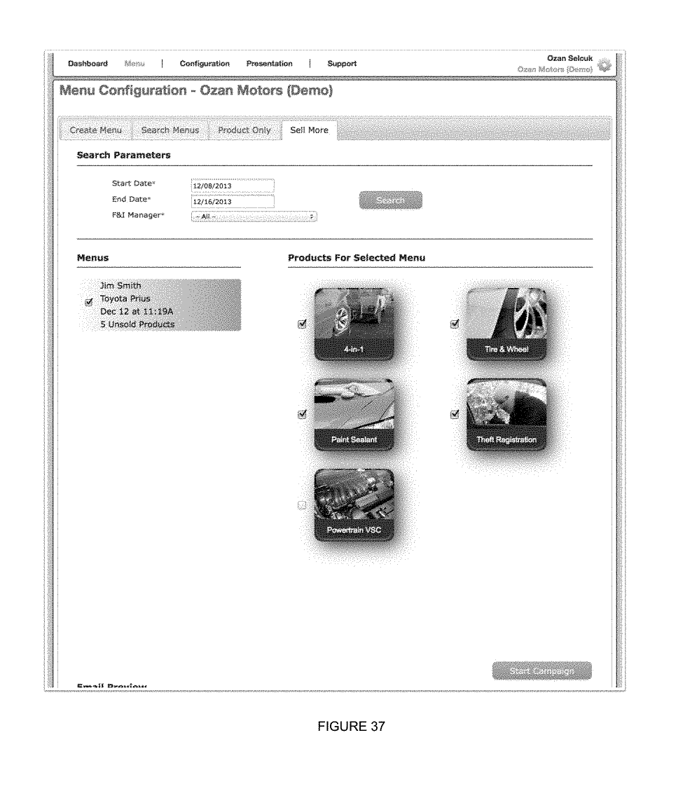

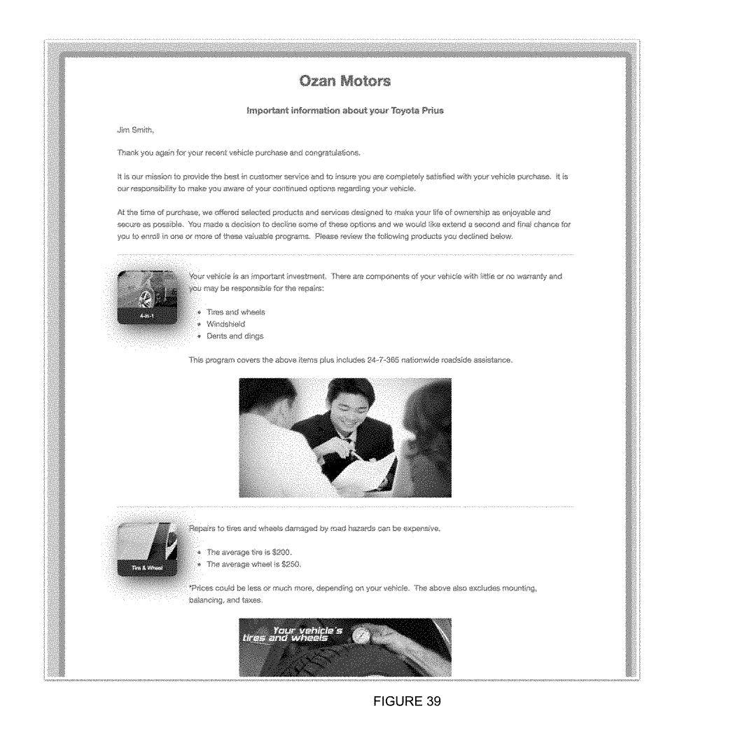

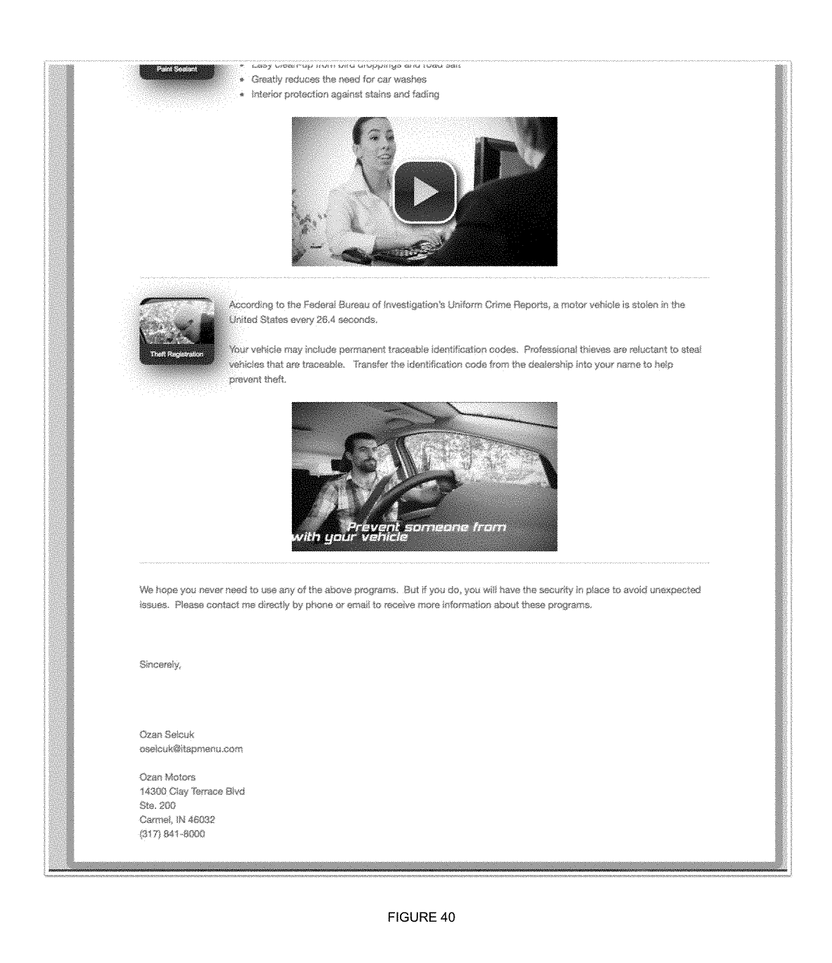

The system includes an F&I database containing information regarding vehicle purchase transactions. The information in the F&I database may be collected during the F&I menu selling process described above. Thus, for each transaction, the F&I database includes contact information for the customer, the vehicle and optional items purchased, and the optional items that were offered and declined at the time of purchase. The information associated with a particular transaction is generally referred to as a “Menu.” The system may be implemented through software running on a general purpose computer, the operation of which can be understood from the screen shots shown in FIGS. 37-42

A salesman user initiates a campaign by selecting the “sell more” tab shown at the top of FIG. 37, setting a date range in the Search Parameters and clicking the search button. This initiates a search of the F&I database that identifies all “Menus” that meet the Search Parameters and are deemed available.

Available “Menus” are those that meet predetermined criteria, for example having the necessary contact information (i.e. email address), and have at least one product deemed suitable for post sale purchase. In other words, if a Menu lacks the necessary contact information or there are no products deemed suitable for post sale purchase, the Menu is not available and is not identified. Products in a Menu may be deemed suitable for post sale purchase if it (a) was available at the time of purchase, (b) was declined by the buyer, and (c) is not a product that has been disallowed. An example of a disallowed product would be certain insurance products, such as GAP insurance. Certain products may also be disallowed when other products have been purchased. For example, the purchase of a 100K mile extended warranty may disallow a 50K mile warranty product.

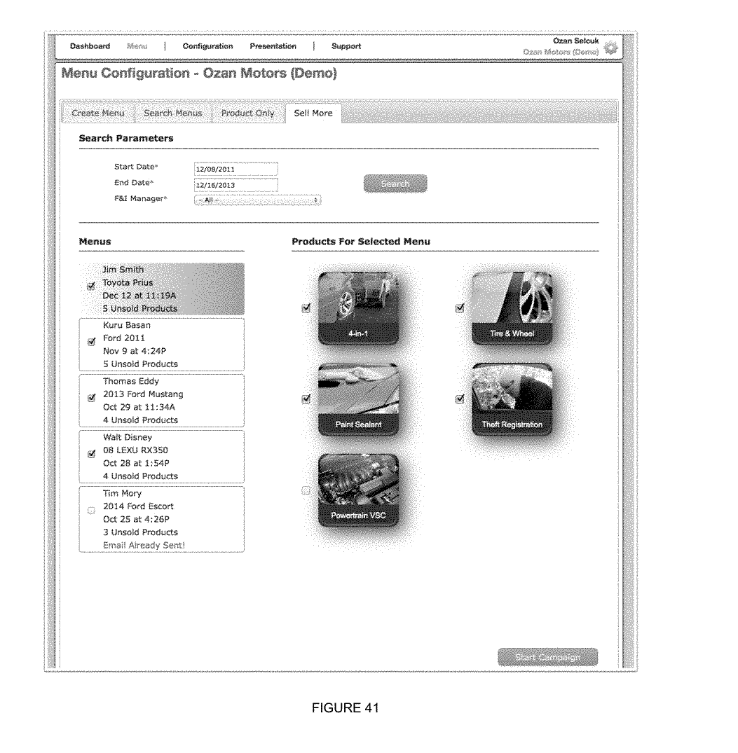

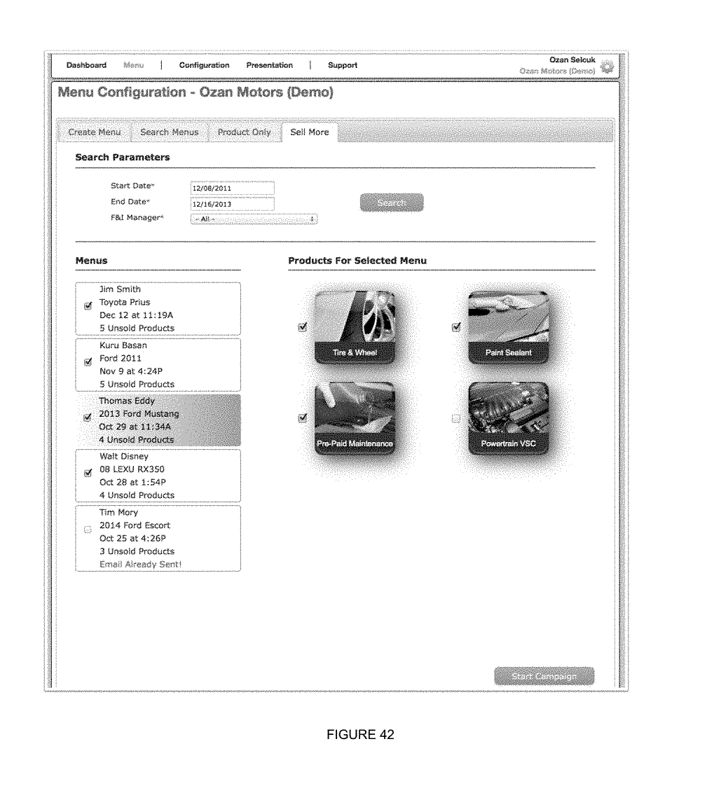

All available Menus meetings the Search Criteria are shown in a list under the “Menus” heading. The listing shown in FIG. 37 shows one available Menu, the listing shown in FIG. 41 shows five available Menus, and the listing shown in FIG. 42 shows five available Menus. For each Menu in the list, representative information for the transaction is shown. Thus, for the single Menu shown in FIG. 37, the purchaser's name is Jim Smith, the vehicle purchased is a Toyota Prius, the purchase date is December 12, and the number of F&I menu items that Jim Smith declined at the time of sale is 5. These five items are represented by the five icons shown on the right side of FIGS. 37 and 41, and in both FIGS. 37 and 41, Jim Smith's Menu is highlighted on the left side so as to visually represent that it is Jim Smith's icons that are being shown on the right. FIG. 42 shows the highlighting being changed to the Thomas Eddy Menu in the middle of the list, and thus the icons displayed on the right side of FIG. 42 correspond to the four products Thomas Eddy declined to purchase.

Turning back to FIG. 37, which shows the Jim Smith's Menu on the left and Jim Smith's icons on right, to the left side of each of Jim Smith's icons there is a check box. The box is checked for the top four icon but unchecked for the bottom most icon. This is to represent that the top four icons correspond to products that have been deemed suitable for post sale purchase whereas the bottom icon corresponds to a product that has not been deemed suitable for post sale purchase. The number of products deemed suitable in each Menu shown in the list can vary, but will be at least one. This is because, as explained above, if none of the products for a particular Menu are deemed suitable for post sale purchase, the Menu would not be considered available and thus would not have been returned in the search. The boxes are automatically checked for those products that meet the sell more criteria, but the status of each check box can be altered manually by the user.

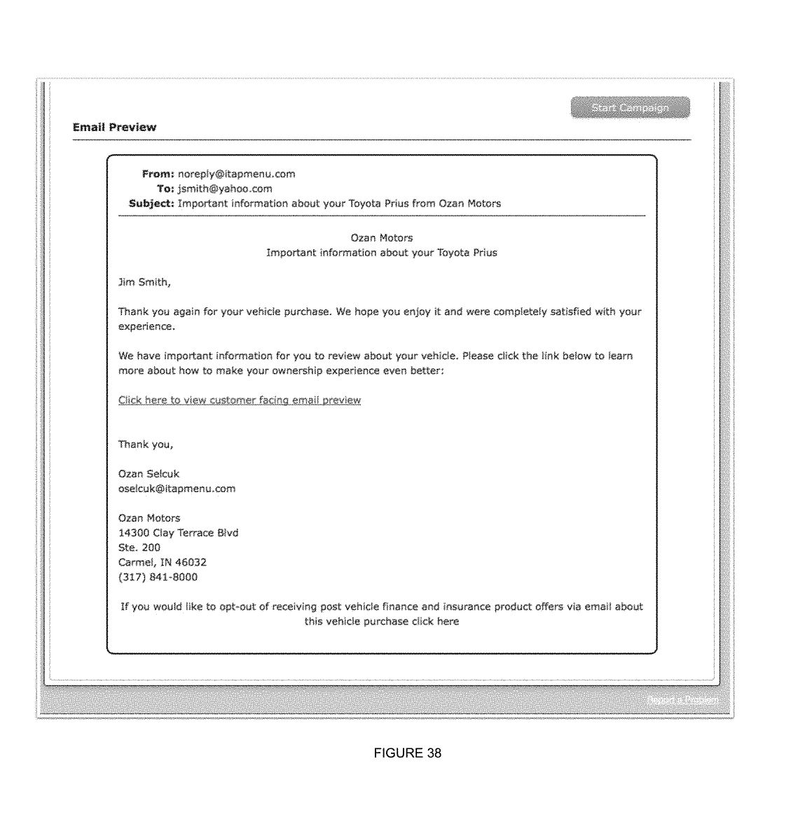

There is also a check box to the left of the Jim Smith Menu that is also shown as being checked. The check mark in this box indicates that Jim Smith has been selected to receive a post sale email. A preview of the email to Jim Smith is automatically generated and shown in FIG. 38, which is actually accessed by scrolling down the page shown in FIG. 37. The email identifies the purchaser (Jim Smith) and the vehicle purchased (Toyota Prius) and includes a hyperlink. Clicking the hyperlink directs the recipient's browser to a customized sell more campaign complete with product descriptions, interactive icons, and videos. The content of this campaign is specific to the vehicle Jim Smith purchased and tailored based on what is in Jim Smith's Menu. Thus, the content of Jim Smith's sell more campaign may be directed to the products for his vehicle corresponding to the boxes checked in FIG. 37 but not to the product for his vehicle whose box is unchecked in FIG. 37, assuming the salesman user does not manually make any changes to the check boxes before sending the email.

The sell more campaign when multiple Menus are returned in the search proceeds in similar fashion. Thus, with the Jim Smith Menu selected as shown in FIG. 41, the user can review and make changes to Jim Smith's menu items (e.g. manually check or uncheck boxes for the icons) and view a preview for the email to Jim Smith. If for some reason the user decides to exclude Jim Smith from the campaign, he can manually deselect Jim Smith by unchecking the box for the Jim Smith Menu. By changing the selection to the Thomas Eddy Menu as shown in FIG. 42, the user can make changes to Thomas Eddy's menu items and view a preview for the email to Thomas Eddy. When he has completed his review or is otherwise satisfied, he then clicks the “Start Campaign” button, which has the effect of sending the customized emails to all of the recipients whose Menu's are selected.

Of note, the check box next to the Tim Mory Menu is unchecked, indicating that an email to Tim Mory is not being sent. This is because, once an email is sent to a customer, a flag is set in that customer's Menu to automatically deselect the Menu should it appear in any later searches. By setting a flag, the Menu is still available such that it can appear in search results, thereby giving the salesman user the opportunity to manually select the recipient to receive a follow up email, but preventing the recipient from being automatically sent additional emails.

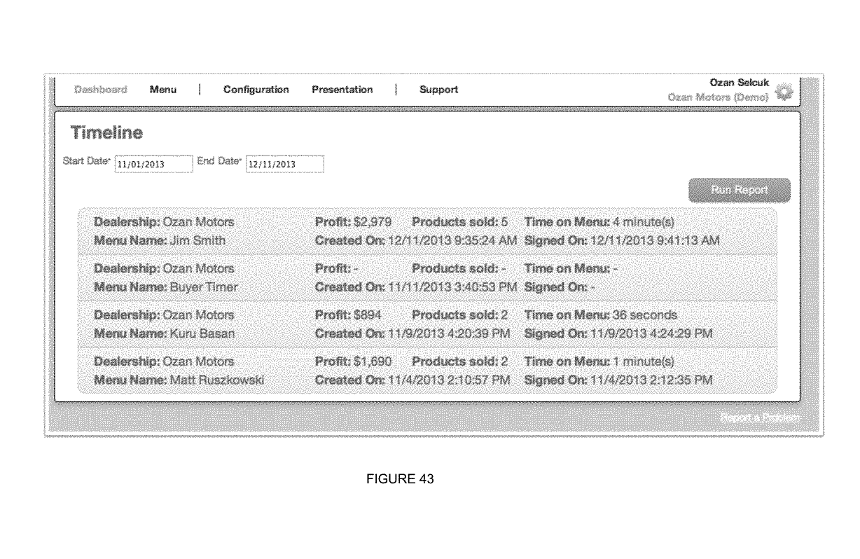

The present F&I menu system may also include a feature that stores the information concerning the interactions with the F&I menu selection system during the sales process and then generates a timeline report of those interactions for use by the sales manager. This timeline report may show, for example, the sequence of menu items presented to or viewed by the customer, the amount of time spent reviewing individual product details, and the sequence of all of the changes made throughout the sales process. By providing this information in a timeline format, the system allows the sales manager to more readily monitor the activities of the individual salespeople, for example to monitor or establish compliance with various sales protocols or best practices. The operation of this timeline report feature is shown in FIGS. 43-53.

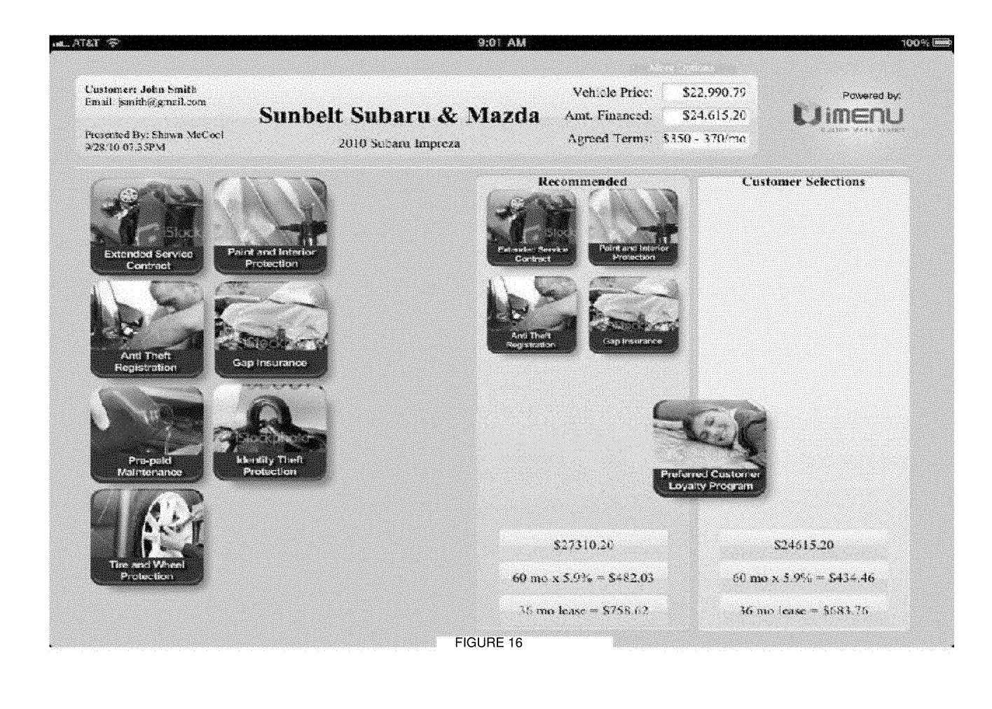

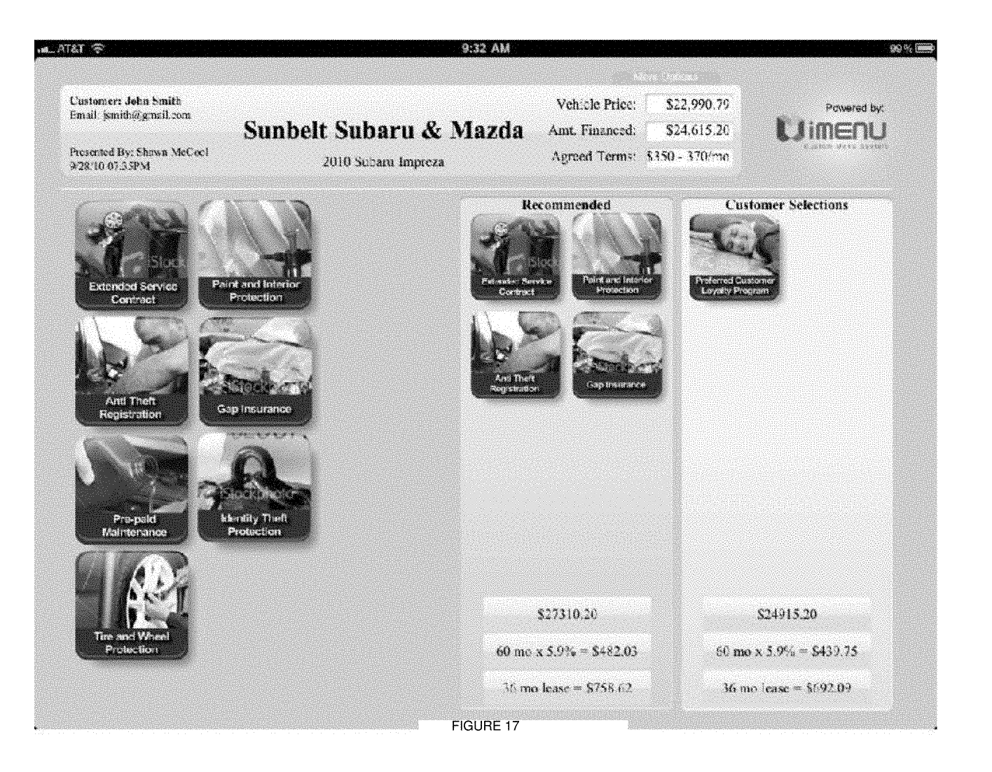

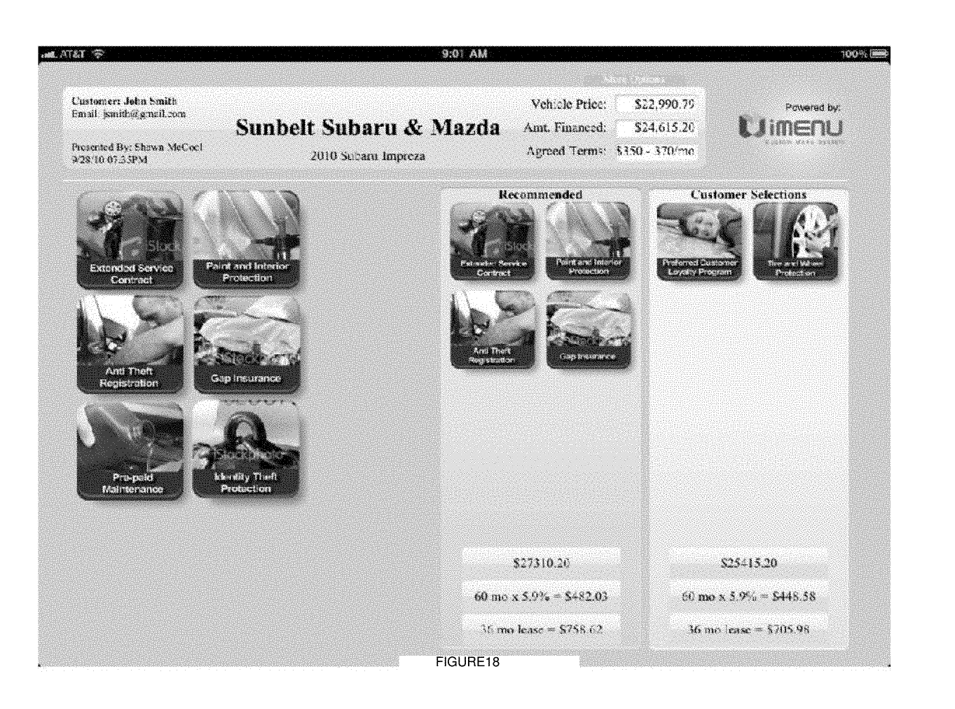

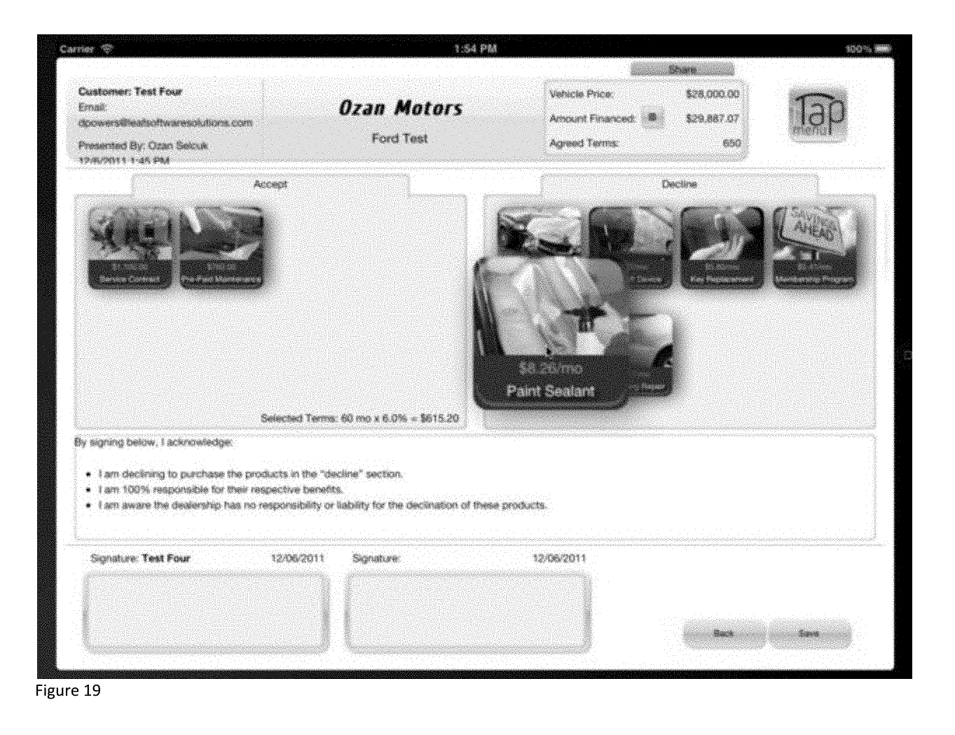

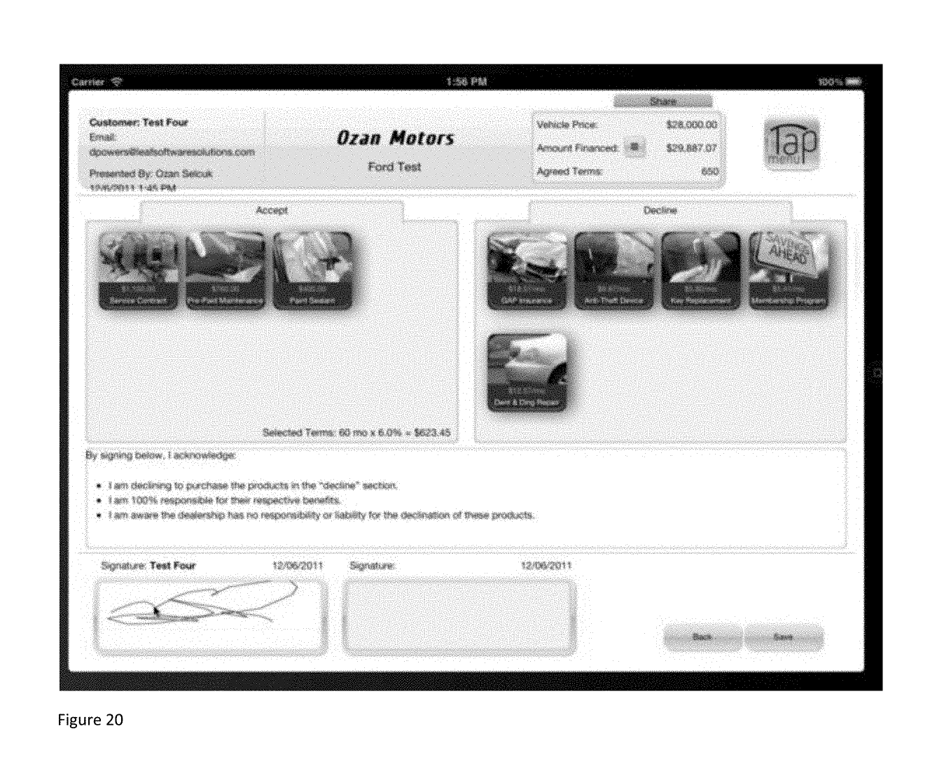

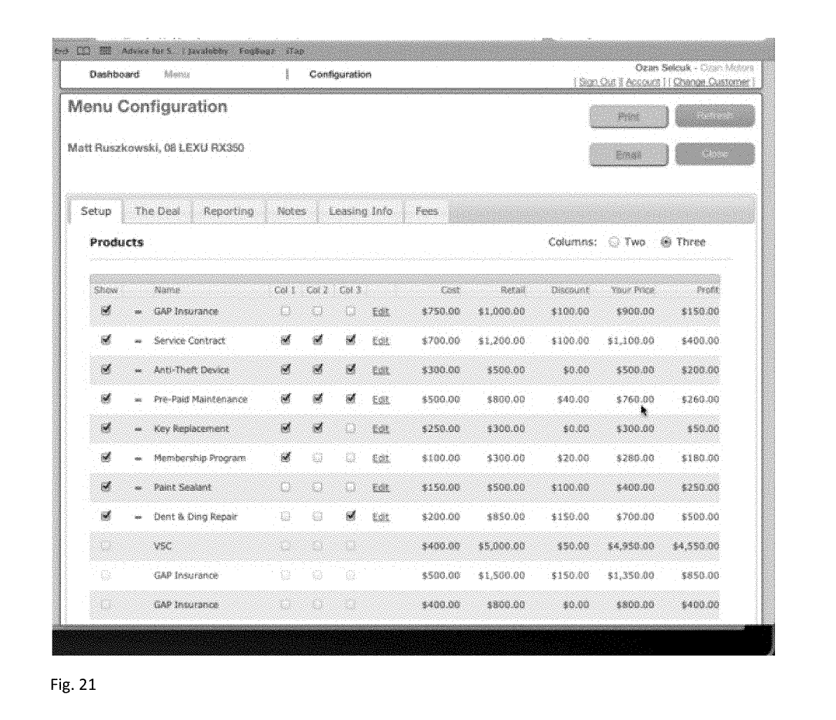

FIG. 43 shows the results of a search for available Menus to be analyzed in a timeline report showing 4 available Menus. As noted previously, each Menu corresponds to a different customer interaction, and the data associated with each Menu is collected via the interaction with the visual user interface described above in connection with FIGS. 1-35. In FIG. 43, each of the four available Menus is identified with summary information concerning the respective customer interaction. As illustrated, the information includes identifying information (i.e. Menu name) as well the total profit from the sale, the number of products (i.e. optional items) sold, and the total time the F&I Menu system was in use during the sale.

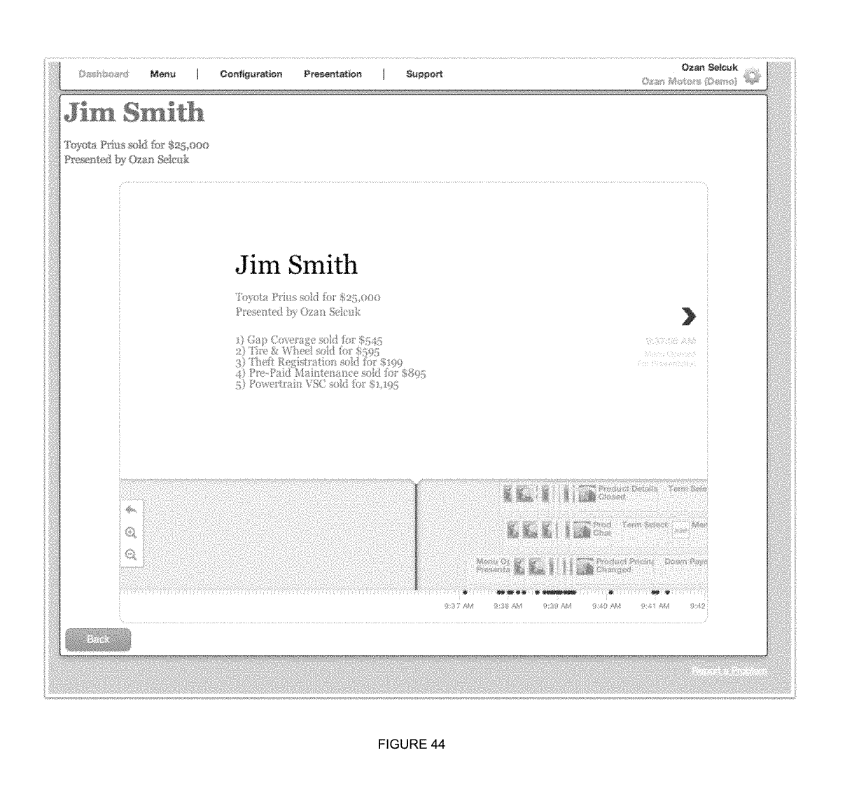

FIG. 44 shows the introductory screen for the timeline report that is generated by selecting the Jim Smith Menu shown in FIG. 43. This introductory screen has an upper section showing a summary of the Jim Smith deal, identifying the vehicle sold (Toyota Prius) and the five optional items that Jim Smith purchased, along with associated pricing information. Along the bottom of the screen is a linear timeline with a series of dots along its bottom edge and a series of corresponding icons arranged above the dots. Each of these dots and icons are associated with an event from the transaction and are arranged along the lower section of the screen in correspondence with the timing of each event. The user can then scroll through the events in the sequence to cause additional details of each event to be displayed in the upper portion of the screen.

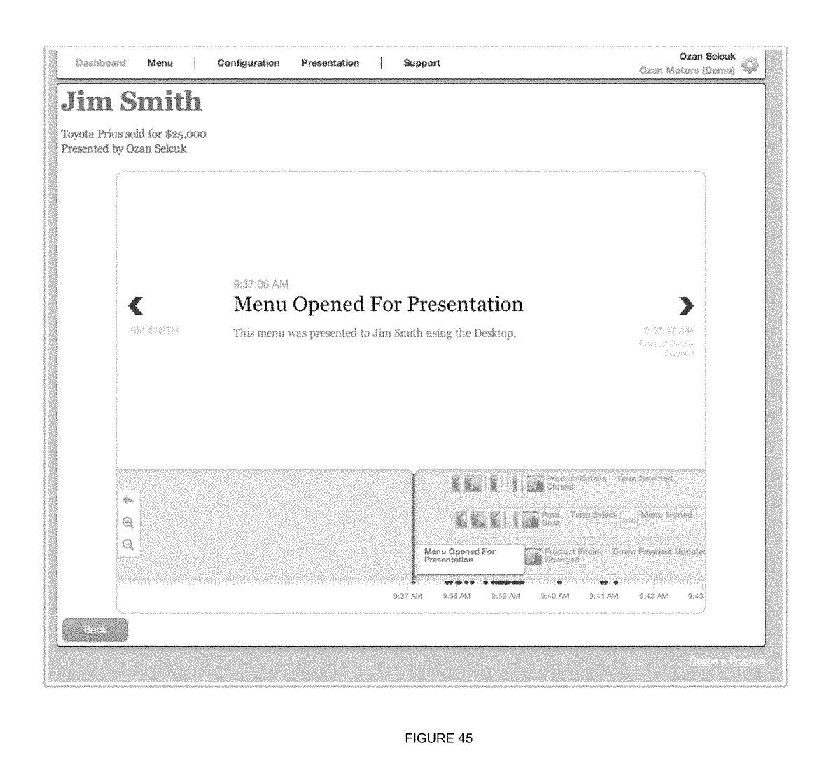

FIG. 45 shows the timeline report upon selection of the first event in the sequence, which corresponds to the opening of the menu for presentation to Jim Smith. The left side of the flag and the dot corresponding to this event are aligned with a central line in the timeline to indicate that the details from this event are being displayed in the upper section. The flag itself is also brought to the forefront and set off in a different color to further indicate the event being displayed.

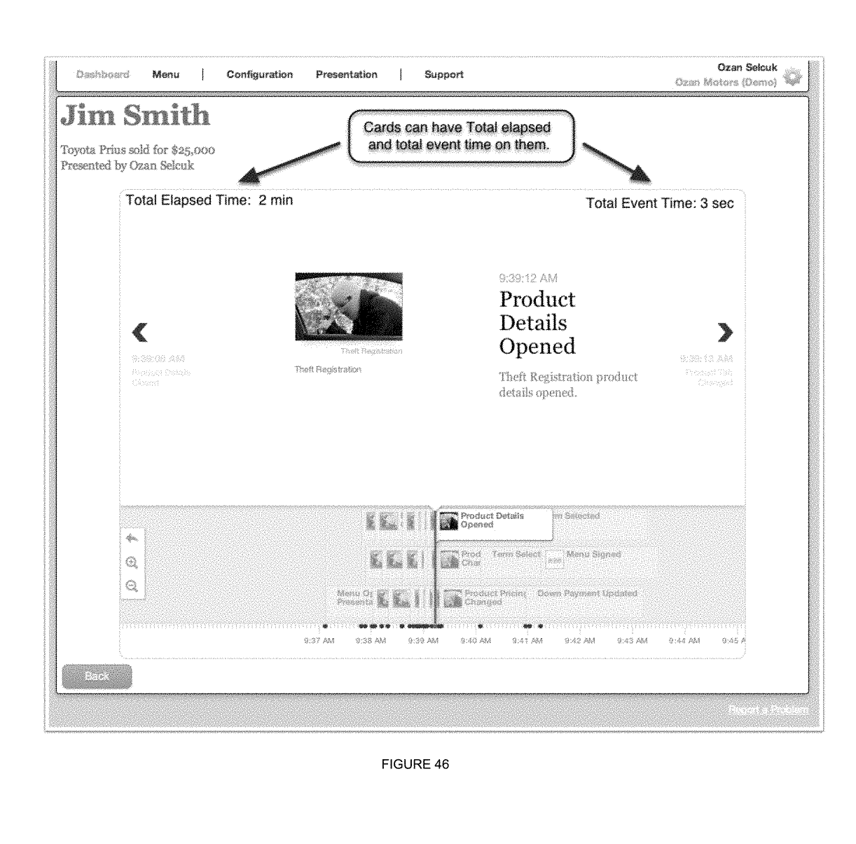

FIG. 46 shows a timeline report screen for the opening of the product details for the theft registration product. As is indicated by the presence of the central line in the lower section being in near the middle of the event sequence, this event occurred near the middle of the Jim Smith deal. FIG. 46 also shows an optional feature, which is the inclusion of the elapsed time for the deal in the upper left corner and an elapsed time for the particular event being displayed in the upper right corner.

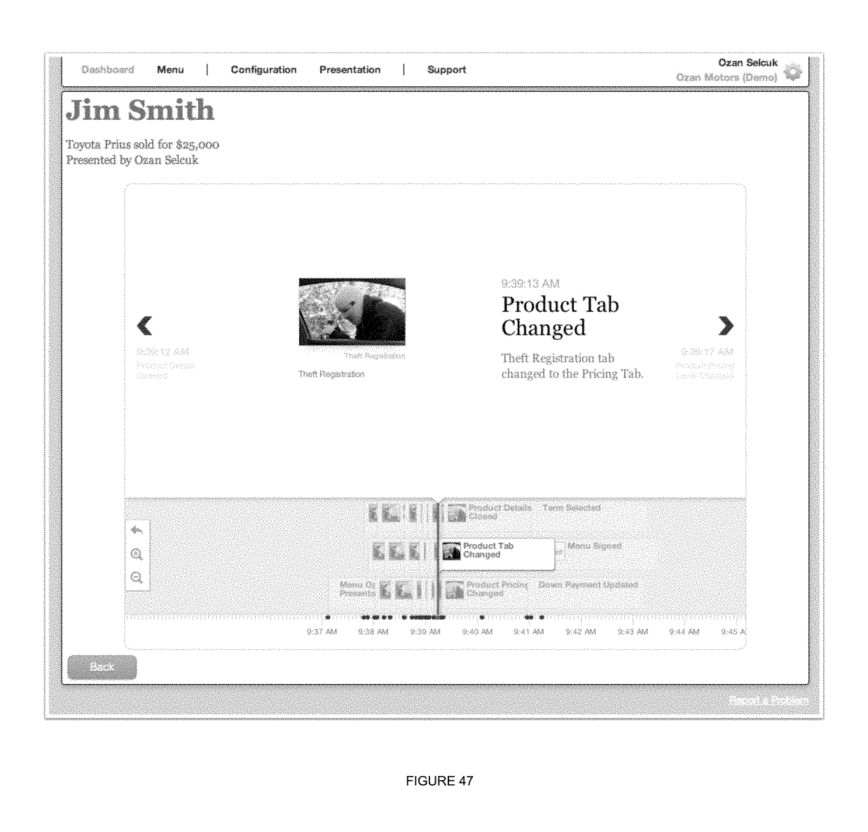

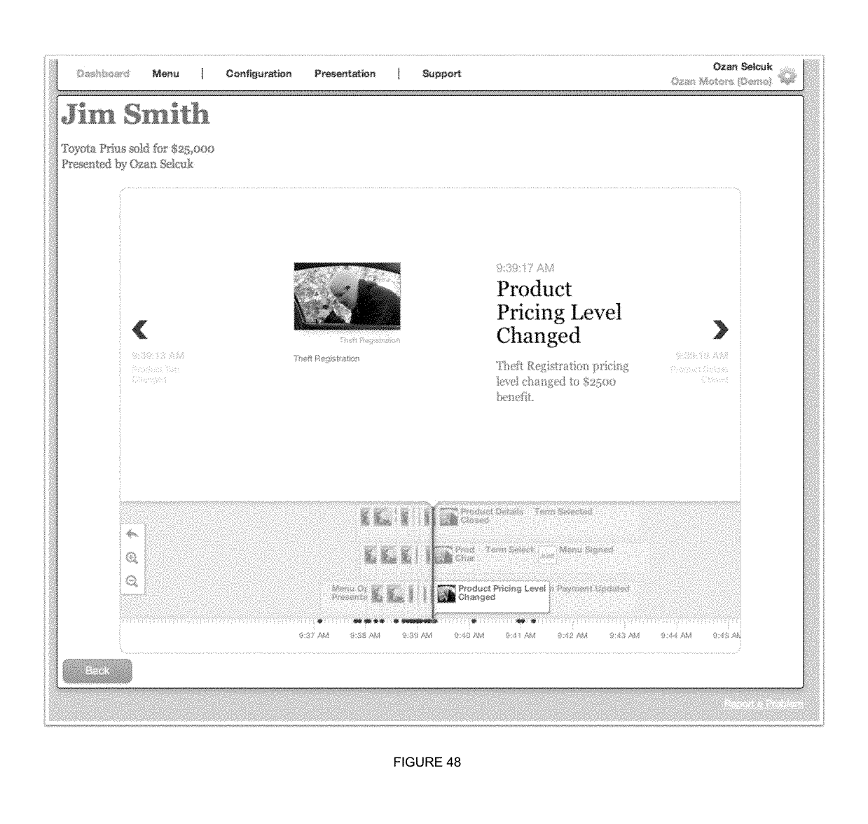

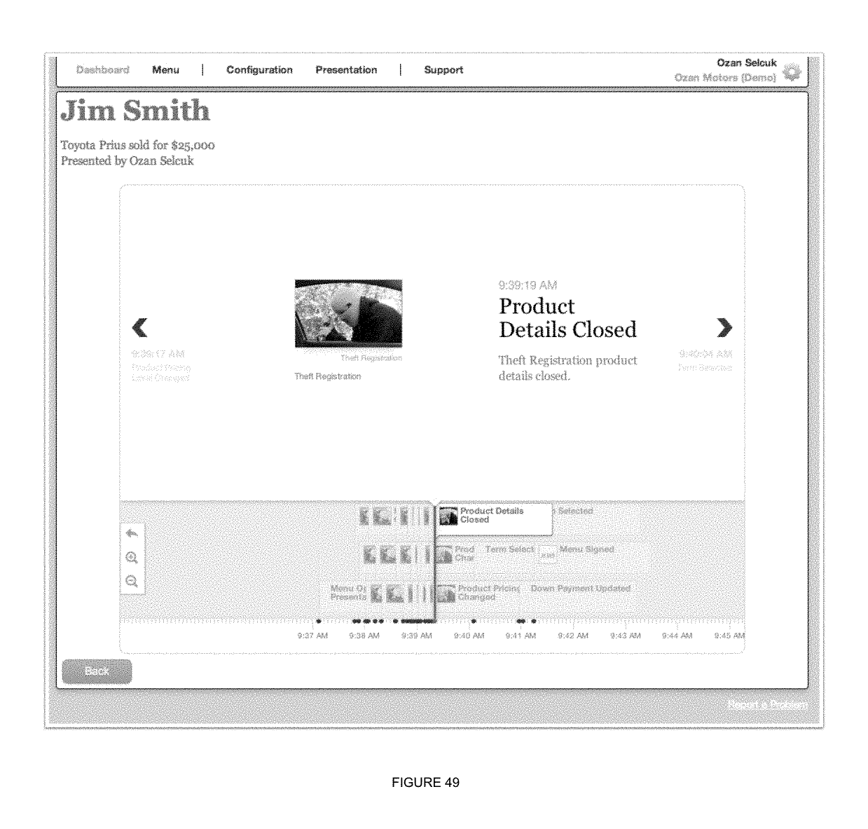

FIG. 47 shows the timeline report screen for the next event after the event shown in FIG. 46, which in this case corresponds to the theft registration tab being changed to the pricing tab. This screen is accessed by clicking the arrow on the right side of FIG. 46 or by selecting the associated flag for the event in the lower section of the screen. FIG. 48 shows the timeline report for the event following the event of FIG. 47, which in this case corresponds to a change in the pricing level of the theft registration product. FIG. 49 shows the timeline report for the event following the event of FIG. 48, which corresponds to the closing of the theft registration product details. Accordingly, by scrolling through the various events associated with the theft registration product, a sales manager can readily see how long the customer and/or salesman paid attention to this product.

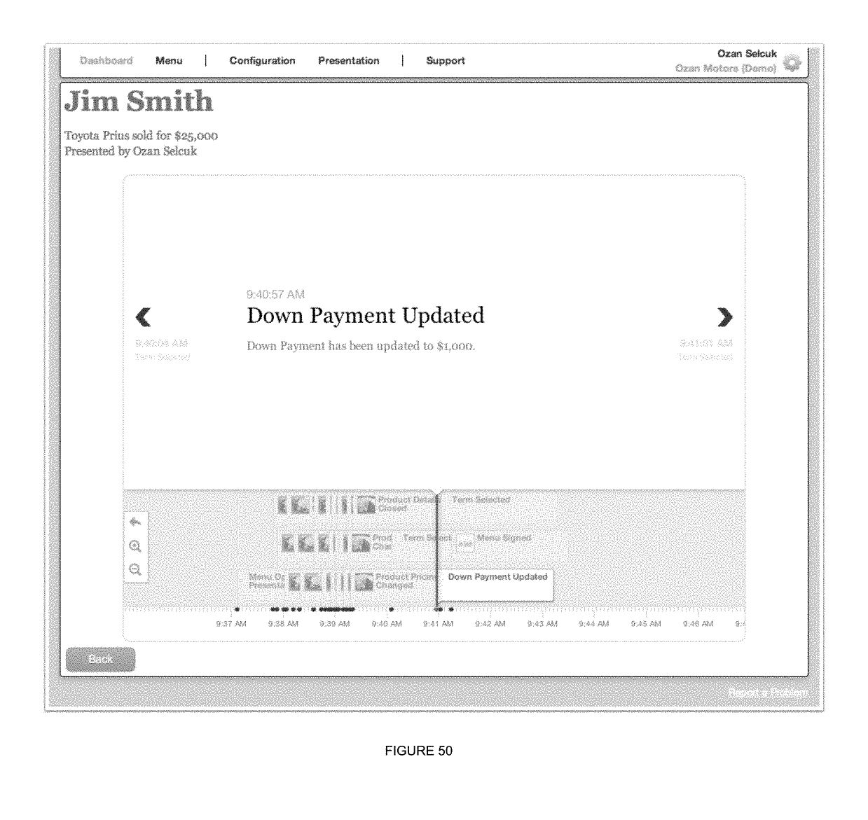

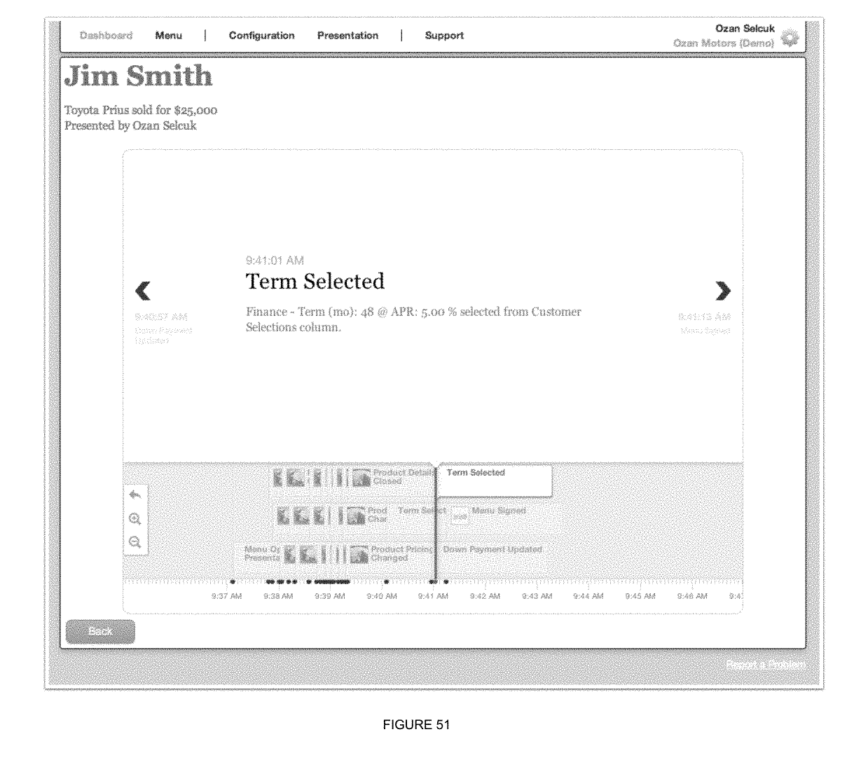

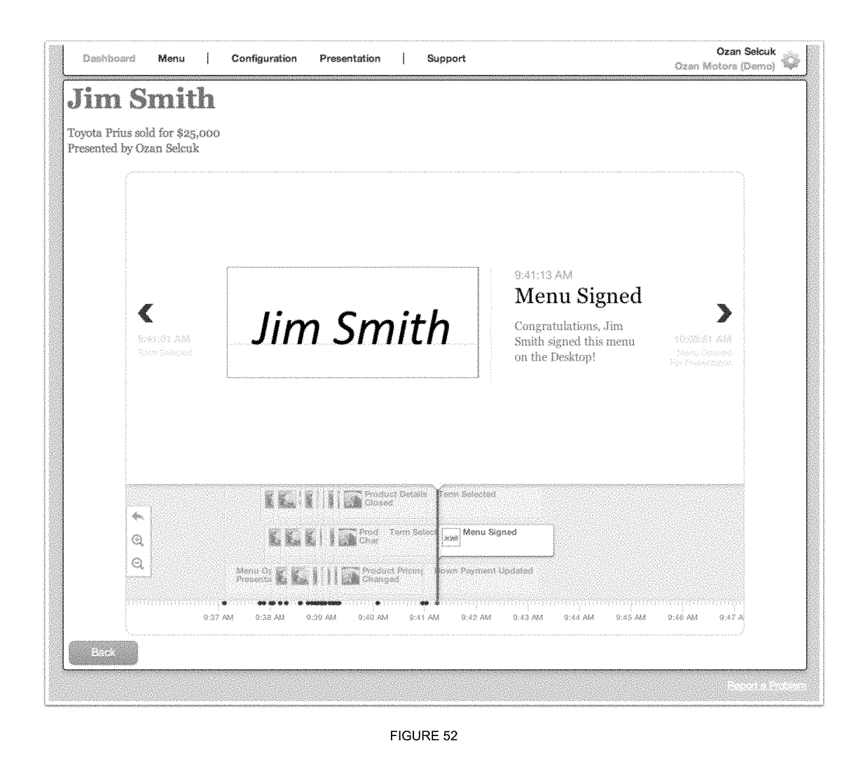

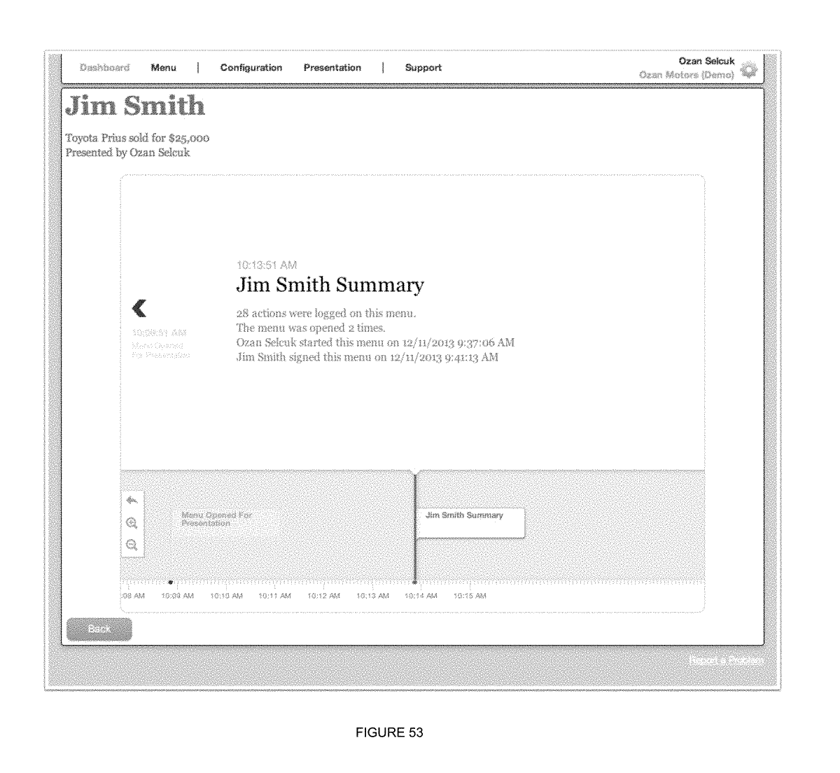

FIG. 50 shows the timeline report for when the down payment was updated to $1,000. FIG. 51 shows the timeline report for a modification of the payment term. FIG. 52 shows the timeline report for when Jim Smith signed the Menu. FIG. 53 shows the concluding timeline report screen for the Jim Smith deal.

While the invention has been illustrated and described in detail in the foregoing drawings and description, the same is to be considered as illustrative and not restrictive in character, it being understood that only illustrative embodiments thereof have been shown and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1. A method for sending post-sale electronic communications to different vehicle purchasers regarding previously declined optional items, comprising:
designating a first set of periodic payment terms;
designating a second set of periodic payment terms that is different than the first set of periodic payment terms;
providing a physical display displaying a visual user interface comprising:
F&I icons each representing an F&I item having an associated price,
an unselected F&I items area displaying unselected F&I icons;
a selected F&I items area displaying selected F&I icons;
a base price area displaying the base cost of the vehicle without any selected F&I items;
a first with-F&I items price area displaying the first set of periodic payment terms and a first periodic payment amount for the vehicle and F&I items displayed in the selected F&I items area, the first periodic payment amount being calculated using the first set of periodic payment terms;
a second with-F&I items price area displaying the second set of periodic payment terms and a second periodic payment amount for the vehicle and F&I items displayed in the selected F&I items area, the second periodic payment amount being calculated using the second set of periodic payment terms;
moving an F&I icon between the unselected F&I items area and the selected F&I items area, and upon such moving, instantly:
recalculating and displaying the first periodic payment amount for the vehicle and F&I items displayed in the selected F&I items area using the first set of periodic payment terms; and
recalculating and displaying the second periodic payment amount for the vehicle and F&I items displayed in the selected F&I items area using the second set of periodic payment terms; and
selecting one or more F&I items to acquire with the vehicle;
displaying a signature area;
capturing an electronic signature of a customer; and
providing an F&I database having information regarding vehicle purchases, and for each such purchase, information regarding:
electronic contact information regarding an associated vehicle purchaser;
the vehicle purchased;
a plurality of optional items offered to the associated vehicle purchaser at the time of purchase, and for each of such optional items, an indicator of whether the associated vehicle purchaser declined the purchase of the optional item at the time of purchase, and an indicator of whether the optional item is available for post sale purchase according to predetermined criteria;
offering optional items for a vehicle to the customer;
storing in the F&I database for each purchased vehicle
an image of the captured signature, and an identification of the F&I items that are not in the selected F&I items area;
the indicator for each optional item indicating whether the associated vehicle purchaser declined the purchase of the optional item at the time of purchase;
providing a computer;
making available for selection only those purchase transactions in the F&I database for which the customer rejected the purchase of an optional item that is available for post sale purchase according to predetermined criteria;
selecting multiple purchase transactions in the database from the purchase transactions made available;
simultaneously generating and transmitting using the computer multiple electronic communications to different customers associated with selected transactions, wherein each of the electronic communications:
identifies the customer and the vehicle purchased; and
comprises a hyperlink to information regarding one or more of the optional items that the customer had declined to purchase and which is available for post sale purchase; and
selecting a hyperlink in one of the simultaneously generated electronic communications;
receiving an electronic communication from the selected hyperlink; transmitting in response to the received hyperlink information regarding at least one optional item that is available for post sale purchase according to predetermined criteria that the customer declined to purchase.

2. A method for sending post-sale electronic communications to different vehicle purchasers regarding previously declined optional items, comprising:
providing a computer;
provide an F&I database having information regarding vehicle purchases, and for each such purchase, information regarding:
electronic contact information regarding the purchaser;
the vehicle purchased;
a plurality of optional items offered to the purchaser at the time of purchase, and for each of such optional items, an indicator of whether the purchaser declined the purchase of the optional item at the time of purchase, and an indicator of whether the optional item is available for post sale purchase according to predetermined criteria;
offering optional items for a vehicle to a vehicle purchaser;
storing in the F&I database for each purchased vehicle the indicator for each optional item indicating whether the purchaser declined the purchase of the optional item at the time of purchase;
making available for selection only those purchase transactions in the F&I database for which the purchaser rejected the purchase of an optional item that is available for post sale purchase according to the predetermined criteria;
selecting multiple purchase transactions in the database from the purchase transactions made available;
simultaneously generating and transmitting using the computer multiple electronic communications to different purchasers associated with selected transactions, wherein each of the electronic communications:
identifies the purchaser and the vehicle purchased; and
comprises a hyperlink to information regarding one or more of the optional items that the purchaser had declined to purchase and which is available for post sale purchase according to predetermine criteria; and
selecting the hyperlink in one of the simultaneously generated electronic communications;
receiving an electronic communication from the selected hyperlink;
transmitting in response to the received hyperlink information regarding at least one optional item that is available for post sale purchase according to predetermined criteria that the purchaser declined to purchase.

3. The method of claim 2 wherein the electronic contact information includes an email address.

4. The method of claim 2 wherein the electronic contact information includes an SMS address.

5. The method of claim 2 wherein the step of selecting multiple transactions includes a selection of multiple transactions based on the date of the purchase.
